(19) United States
(12) Patent Application Publication
(10) Pub. No.: US 2026/0128680 A1
(43) Pub. Date: May 7, 2026

(54) ELECTRIC POWER CONVERSION APPARATUS

(71) Applicant: TDK Corporation, Tokyo (JP)

(72) Inventor: Ryosuke USHIKUBO, Tokyo (JP)

(73) Assignee: TDK Corporation, Tokyo (JP)

(21) Appl. No.: 19/371,482

(22) Filed: Oct. 28, 2025

(30) Foreign Application Priority Data
Nov. 6, 2024 (JP) 2024-194631
Sep. 25, 2025 (JP) 2025-158981

(51) Int. Cl. H02M 3/335; H02J 7/34; H02M 1/00; H02M 1/08; H02M 1/14

(52) U.S. Cl. CPC H02M 3/33561; H02J 7/342; H02M 1/0009; H02M 1/08; H02M 1/14; H02M 3/33571; H02M 3/33592; H02J 2207/20

(57) ABSTRACT

An electric power conversion apparatus includes: a first electric power terminal; an inductor; a capacitor; a switching circuit including a first switching device and a second switching device; a transformer including a first winding and a second winding; a rectifying circuit including a third switching device and a fourth switching device; a smoothing circuit; a second electric power terminal; and a control circuit configured to control operations of the switching circuit and the rectifying circuit by performing first control in which a first operation, a second operation, a third operation, a fourth operation, a fifth operation, and a sixth operation are performed in this order repeatedly.

### CROSS-REFERENCE TO RELATED APPLICATIONS

The present application claims priority from Japanese Patent Application No. 2024-194631 filed on Nov. 6, 2024 and Japanese Patent Application No. 2025-158981 filed on Sep. 25, 2025, the entire contents of each of which are hereby incorporated by reference.

### BACKGROUND

The disclosure relates to an electric power conversion apparatus that converts electric power.

Examples of an electric power conversion apparatus include what is called an active clamp forward DC-DC converter. For example, reference is made to International Publication No. WO 2004/001937.

### SUMMARY

An electric power conversion apparatus according to one embodiment of the disclosure includes a first electric power terminal, an inductor, a capacitor, a switching circuit, a transformer, a rectifying circuit, a smoothing circuit, a second electric power terminal, and a control circuit. The first electric power terminal includes a first coupling terminal and a second coupling terminal. The inductor has a first end coupled to the first coupling terminal and a second end coupled to a first node. The capacitor has a first end coupled to the first coupling terminal or the second coupling terminal and a second end coupled to a second node. The switching circuit includes a first switching device and a second switching device. The first switching device has a first end coupled to a third node and a second end coupled to the second coupling terminal. The second switching device has a first end coupled to the second node and a second end coupled to the third node. The transformer includes a first winding and a second winding. The first winding has a first end coupled to the first node and a second end coupled to the third node. The second winding has a first end coupled to a fourth node and a second end coupled to a fifth node. The rectifying circuit includes a third switching device and a fourth switching device. The third switching device has a first end coupled to the fifth node and a second end coupled to a sixth node. The fourth switching device has a first end coupled to the fourth node and a second end coupled to the sixth node. The smoothing circuit is coupled to the fourth node and the sixth node. The second electric power terminal is coupled to the smoothing circuit. The control circuit is configured to control operations of the switching circuit and the rectifying circuit by performing first control in which a first operation, a second operation, a third operation, a fourth operation, a fifth operation, and a sixth operation are performed in this order repeatedly. The first operation includes causing the first switching device, the second switching device, the third switching device, and the fourth switching device to be off. The second operation includes causing the second switching device and the fourth switching device to be on and causing the first switching device and the third switching device to be off. The third operation includes causing the third switching device and the fourth switching device to be on and causing the first switching device and the second switching device to be off. The fourth operation includes causing the third switching device to be on and causing the first switching device, the second switching device, and the fourth switching device to be off. The fifth operation includes causing the first switching device and the third switching device to be on and causing the second switching device and the fourth switching device to be off. The sixth operation includes causing the third switching device to be on and causing the first switching device, the second switching device, and the fourth switching device to be off.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a circuit diagram illustrating a configuration example of an electric power conversion apparatus according to one example embodiment of the disclosure.

FIG. 2 is an explanatory diagram illustrating an example of operation modes of the electric power conversion apparatus illustrated in FIG. 1.

FIG. 3 is a timing waveform diagram illustrating an operation example of the electric power conversion apparatus illustrated in FIG. 1.

FIG. 4A is an explanatory diagram illustrating an operation state of the electric power conversion apparatus illustrated in FIG. 1.

FIG. 4B is an explanatory diagram illustrating another operation state of the electric power conversion apparatus illustrated in FIG. 1.

FIG. 4C is an explanatory diagram illustrating another operation state of the electric power conversion apparatus illustrated in FIG. 1.

FIG. 4D is an explanatory diagram illustrating another operation state of the electric power conversion apparatus illustrated in FIG. 1.

FIG. 4E is an explanatory diagram illustrating another operation state of the electric power conversion apparatus illustrated in FIG. 1.

FIG. 4F is an explanatory diagram illustrating another operation state of the electric power conversion apparatus illustrated in FIG. 1.

FIG. 4G is an explanatory diagram illustrating another operation state of the electric power conversion apparatus illustrated in FIG. 1.

FIG. 4H is an explanatory diagram illustrating another operation state of the electric power conversion apparatus illustrated in FIG. 1.

FIG. 4I is an explanatory diagram illustrating another operation state of the electric power conversion apparatus illustrated in FIG. 1.

FIG. 4J is an explanatory diagram illustrating another operation state of the electric power conversion apparatus illustrated in FIG. 1.

FIG. 4K is an explanatory diagram illustrating another operation state of the electric power conversion apparatus illustrated in FIG. 1.

FIG. 4L is an explanatory diagram illustrating another operation state of the electric power conversion apparatus illustrated in FIG. 1.

FIG. 5 is a timing waveform diagram illustrating another operation example of the electric power conversion apparatus illustrated in FIG. 1.

FIG. 6 is a timing waveform diagram illustrating another operation example of the electric power conversion apparatus illustrated in FIG. 1.

FIG. 7 is a timing waveform diagram illustrating an operation example of an electric power conversion apparatus according to a reference example.

FIG. 8 is a timing waveform diagram illustrating an operation example of an electric power conversion apparatus according to another reference example.

FIG. 9 is a characteristic diagram illustrating a characteristic example of the electric power conversion apparatus illustrated in FIG. 1.

FIG. 10 is a circuit diagram illustrating a configuration example of an electric power conversion apparatus according to one example embodiment of the disclosure.

FIG. 11 is a timing waveform diagram illustrating an operation example of the electric power conversion apparatus illustrated in FIG. 10.

FIG. 12A is an explanatory diagram illustrating an operation state of the electric power conversion apparatus illustrated in FIG. 10.

FIG. 12B is an explanatory diagram illustrating another operation state of the electric power conversion apparatus illustrated in FIG. 10.

FIG. 12C is an explanatory diagram illustrating another operation state of the electric power conversion apparatus illustrated in FIG. 10.

FIG. 12D is an explanatory diagram illustrating another operation state of the electric power conversion apparatus illustrated in FIG. 10.

FIG. 12E is an explanatory diagram illustrating another operation state of the electric power conversion apparatus illustrated in FIG. 10.

FIG. 12F is an explanatory diagram illustrating another operation state of the electric power conversion apparatus illustrated in FIG. 10.

FIG. 12G is an explanatory diagram illustrating another operation state of the electric power conversion apparatus illustrated in FIG. 10.

FIG. 12H is an explanatory diagram illustrating another operation state of the electric power conversion apparatus illustrated in FIG. 10.

FIG. 12I is an explanatory diagram illustrating another operation state of the electric power conversion apparatus illustrated in FIG. 10.

FIG. 12J is an explanatory diagram illustrating another operation state of the electric power conversion apparatus illustrated in FIG. 10.

FIG. 12K is an explanatory diagram illustrating another operation state of the electric power conversion apparatus illustrated in FIG. 10.

FIG. 12L is an explanatory diagram illustrating another operation state of the electric power conversion apparatus illustrated in FIG. 10.

FIG. 12M is an explanatory diagram illustrating another operation state of the electric power conversion apparatus illustrated in FIG. 10.

FIG. 13 is a circuit diagram illustrating a configuration example of an electric power conversion apparatus according to one example embodiment of the disclosure.

FIG. 14 is an explanatory diagram illustrating an example of operation modes of the electric power conversion apparatus illustrated in FIG. 13.

FIG. 15 is a timing waveform diagram illustrating an operation example of the electric power conversion apparatus illustrated in FIG. 13.

FIG. 16A is an explanatory diagram illustrating an operation state of the electric power conversion apparatus illustrated in FIG. 13.

FIG. 16B is an explanatory diagram illustrating another operation state of the electric power conversion apparatus illustrated in FIG. 13.

FIG. 16C is an explanatory diagram illustrating another operation state of the electric power conversion apparatus illustrated in FIG. 13.

FIG. 16D is an explanatory diagram illustrating another operation state of the electric power conversion apparatus illustrated in FIG. 13.

FIG. 16E is an explanatory diagram illustrating another operation state of the electric power conversion apparatus illustrated in FIG. 13.

FIG. 16F is an explanatory diagram illustrating another operation state of the electric power conversion apparatus illustrated in FIG. 13.

FIG. 16G is an explanatory diagram illustrating another operation state of the electric power conversion apparatus illustrated in FIG. 13.

FIG. 16H is an explanatory diagram illustrating another operation state of the electric power conversion apparatus illustrated in FIG. 13.

FIG. 16I is an explanatory diagram illustrating another operation state of the electric power conversion apparatus illustrated in FIG. 13.

FIG. 16J is an explanatory diagram illustrating another operation state of the electric power conversion apparatus illustrated in FIG. 13.

FIG. 16K is an explanatory diagram illustrating another operation state of the electric power conversion apparatus illustrated in FIG. 13.

FIG. 16L is an explanatory diagram illustrating another operation state of the electric power conversion apparatus illustrated in FIG. 13.

FIG. 16M is an explanatory diagram illustrating another operation state of the electric power conversion apparatus illustrated in FIG. 13.

FIG. 17 is a circuit diagram illustrating a configuration example of an electric power conversion apparatus according to a modification example.

### DETAILED DESCRIPTION

What is desired of an electric power conversion apparatus is to reduce energy loss. Expectations are placed on a further reduction in energy loss.

It is desirable to provide an electric power conversion apparatus that makes it possible to reduce energy loss.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings. Note that the description is given in the following order.
1. First Example Embodiment
2. Second Example Embodiment
3. Third Example Embodiment

### First Example Embodiment

### Configuration Example

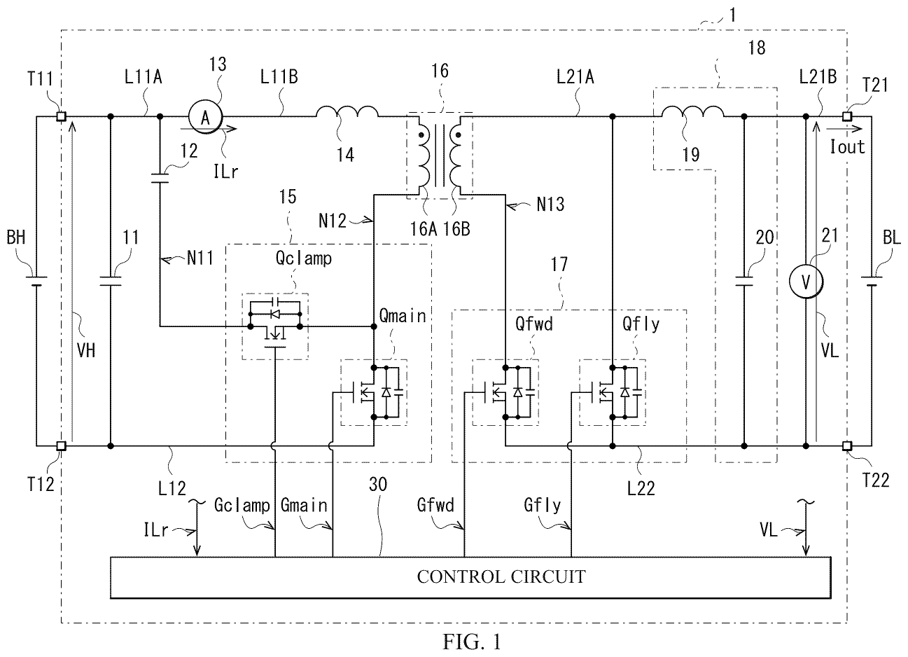

FIG. 1 illustrates a configuration example of an electric power conversion apparatus 1 according to a first example embodiment of the disclosure. In this example, the electric power conversion apparatus 1 may be coupled to a high voltage battery BH and a low voltage battery BL. The electric power conversion apparatus 1 may be configured to convert electric power by stepping down a voltage supplied from the high voltage battery BH, and to supply the converted electric power to the low voltage battery BL. The electric power conversion apparatus 1 may include terminals T11 and T12, a capacitor 11, a capacitor 12, a current sensor 13, an inductor 14, a switching circuit 15, a transformer 16, a rectifying circuit 17, a smoothing circuit 18, a voltage sensor 21, a control circuit 30, and terminals T21 and T22. Primary-side circuitry of the electric power conversion apparatus 1 may include the capacitor 11, the capacitor 12, the current sensor 13, the inductor 14, and the switching circuit 15. Secondary-side circuitry of the electric power conversion apparatus 1 may include the rectifying circuit 17, the smoothing circuit 18, and the voltage sensor 21.

The terminals T11 and T12 may be configured to receive a voltage VH from the high voltage battery BH. In the electric power conversion apparatus 1, the terminal T11 may be coupled to a voltage line L11A, and the terminal T12 may be coupled to a reference voltage line L12. The terminal T11 may be coupled to a positive terminal of the high voltage battery BH, and the terminal T12 may be coupled to a negative terminal of the high voltage battery BH.

The capacitor 11 may have a first end coupled to the voltage line L11A and a second end coupled to the reference voltage line L12.

The capacitor 12 may have a first end coupled to the voltage line L11A and a second end coupled to a node N11.

The current sensor 13 may have a first end coupled to the voltage line L11A and a second end coupled to a voltage line L11B. The current sensor 13 may be configured to detect a current ILr flowing from the voltage line L11A toward the voltage line L11B.

The inductor 14 may have a first end coupled to the voltage line L11B and a second end coupled to a winding 16A of the transformer 16. The winding 16A will be described later.

The switching circuit 15 may be configured to perform switching operations, based on control signals Gmain and Gclamp. The switching circuit 15 may include transistors Qmain and Qclamp. The transistors Qmain and Qclamp may be switching devices that perform switching operations, respectively based on the control signals Gmain and Gclamp. The transistors Qmain and Qclamp may each include an N-type field-effect transistor (FET), for example. The transistors Qmain and Qclamp may each include a body diode and a parasitic capacitor. For example, the body diode of the transistor Qmain may have an anode coupled to a source of a body of the transistor Qmain, and a cathode coupled to a drain of the body of the transistor Qmain. The parasitic capacitor of the transistor Qmain may have a first end coupled to the source of the body of the transistor Qmain and a second end coupled to the drain of the body of the transistor Qmain. This may similarly apply to the transistor Qclamp. Note that although the N-type field-effect transistor may be used in this example, this is non-limiting, and any kind of switching device may be used. The transistor Qmain may have the drain coupled to a node N12, the source coupled to the reference voltage line L12, and a gate to receive the control signal Gmain. The transistor Qclamp may have a drain coupled to the node N11, a source coupled to the node N12, and a gate to receive the control signal Gclamp.

The transformer 16 may be configured to: isolate the primary-side circuitry and the secondary-side circuitry from each other; convert an alternating-current voltage supplied from the primary-side circuitry with a transformation ratio of the transformer 16; and supply the converted alternating-current voltage to the secondary-side circuitry. The transformer 16 may include the winding 16A and a winding 16B. The winding 16A may be a primary winding of the transformer 16. The winding 16A may have a first end coupled to the second end of the inductor 14 and a second end coupled to the node N12. The winding 16B may be a secondary winding of the transformer 16. The winding 16B may have a first end coupled to a voltage line L21A and a second end coupled to a node N13. The voltage line L21A will be described later.

The rectifying circuit 17 may be configured to rectify the alternating-current voltage outputted from the winding 16B of the transformer 16. The rectifying circuit 17 may include transistors Qfwd and Qfly. The transistors Qfwd and Qfly may be switching devices that perform switching operations, respectively based on control signals Gfwd and Gfly. The transistors Qfwd and Qfly may each include, for example, an N-type field-effect transistor, as with the transistors Qmain and Qclamp. The transistors Qfwd and Qfly may each include a body diode and a parasitic capacitor, as with the transistors Qmain and Qclamp. The transistor Qfwd may have a drain coupled to the node N13, a source coupled to a reference voltage line L22, and a gate to receive the control signal Gfwd. The transistor Qfly may have a drain coupled to the voltage line L21A, a source coupled to the reference voltage line L22, and a gate to receive the control signal Gfly.

The smoothing circuit 18 may be configured to smooth the voltage rectified by the rectifying circuit 17. The smoothing circuit 18 may include an inductor 19 and a capacitor 20. The inductor 19 may have a first end coupled to the voltage line L21A and a second end coupled to a voltage line L21B. The capacitor 20 may have a first end coupled to the voltage line L21B and a second end coupled to the reference voltage line L22.

The voltage sensor 21 may have a first end coupled to the voltage line L21B and a second end coupled to the reference voltage line L22. The voltage sensor 21 may be configured to detect a voltage VL at the voltage line L21B with respect to a voltage at the reference voltage line L22.

The control circuit 30 may be configured to control the operation of the electric power conversion apparatus 1, based on the current ILr detected by the current sensor 13 and the voltage VL detected by the voltage sensor 21. For example, the control circuit 30 may control respective operations of the transistors Qmain, Qclamp, Qfwd, and Qfly through the control signals Gmain, Gclamp, Gfwd, and Gfly, based on the voltage VL detected by the voltage sensor 21, to allow the voltage VL to be maintained at a predetermined target voltage. The control circuit 30 may set an operation mode of the electric power conversion apparatus 1, based on the current ILr detected by the current sensor 13. In other words, because the current ILr is a current corresponding to an output current Iout outputted from the terminals T21 and T22 of the electric power conversion apparatus 1, the control circuit 30 may set the operation mode of the electric power conversion apparatus 1 to that corresponding to the output current Iout, based on the current ILr. For example, the control circuit 30 may include a controller such as a microcontroller.

The terminals T21 and T22 may be configured to supply the voltage VL generated by the electric power conversion apparatus 1 to the low voltage battery BL. In the electric power conversion apparatus 1, the terminal T21 may be coupled to the voltage line L21B, and the terminal T22 may be coupled to the reference voltage line L22. Further, the terminal T21 may be coupled to a positive terminal of the low voltage battery BL, and the terminal T22 may be coupled to a negative terminal of the low voltage battery BL.

Here, the terminals T11 and T12 may correspond to a specific but non-limiting example of a “first electric power terminal” in one embodiment of the disclosure. The terminal T11 may correspond to a specific but non-limiting example of a “first coupling terminal” in one embodiment of the disclosure. The terminal T12 may correspond to a specific but non-limiting example of a “second coupling terminal” in one embodiment of the disclosure. The inductor 14 may correspond to a specific but non-limiting example of an “inductor” in one embodiment of the disclosure. The capacitor 12 may correspond to a specific but non-limiting example of a “capacitor” in one embodiment of the disclosure. The switching circuit 15 may correspond to a specific but non-limiting example of a “switching circuit” in one embodiment of the disclosure. The transistor Qmain may correspond to a specific but non-limiting example of a “first switching device” in one embodiment of the disclosure. The transistor Qclamp may correspond to a specific but non-limiting example of a “second switching device” in one embodiment of the disclosure. The transformer 16 may correspond to a specific but non-limiting example of a “transformer” in one embodiment of the disclosure. The winding 16A may correspond to a specific but non-limiting example of a “first winding” in one embodiment of the disclosure. The winding 16B may correspond to a specific but non-limiting example of a “second winding” in one embodiment of the disclosure. The rectifying circuit 17 may correspond to a specific but non-limiting example of a “rectifying circuit” in one embodiment of the disclosure. The transistor Qfwd may correspond to a specific but non-limiting example of a “third switching device” in one embodiment of the disclosure. The transistor Qfly may correspond to a specific but non-limiting example of a “fourth switching device” in one embodiment of the disclosure. The smoothing circuit 18 may correspond to a specific but non-limiting example of a “smoothing circuit” in one embodiment of the disclosure. The terminals T21 and T22 may correspond to a specific but non-limiting example of a “second electric power terminal” in one embodiment of the disclosure. The control circuit 30 may correspond to a specific but non-limiting example of a “control circuit” in one embodiment of the disclosure.

### Operation and Workings

Next, a description will be given of operation and workings of the electric power conversion apparatus 1 of the first example embodiment.

### Outline of Overall Operation

First, an outline of overall operation of the electric power conversion apparatus 1 will be described with reference to FIG. 1. The control circuit 30 may generate the control signals Gmain, Gclamp, Gfwd, and Gfly, based on the voltage VL. The switching circuit 15 may perform switching operations, based on the control signals Gmain and Gclamp. The rectifying circuit 17 may perform switching operations, based on the control signals Gfwd and Gfly. The electric power conversion apparatus 1 may thereby convert electric power supplied from the high voltage battery BH and supply the converted electric power to the low voltage battery BL. The control circuit 30 may control the operations of the transistors Qmain, Qclamp, Qfwd, and Qfly through the control signals Gmain, Gclamp, Gfwd, and Gfly, based on the voltage VL detected by the voltage sensor 21, to allow the voltage VL to be maintained at the predetermined target voltage. Further, the control circuit 30 may set the operation mode of the electric power conversion apparatus 1, based on the current ILr detected by the current sensor 13.

### Detailed Operation

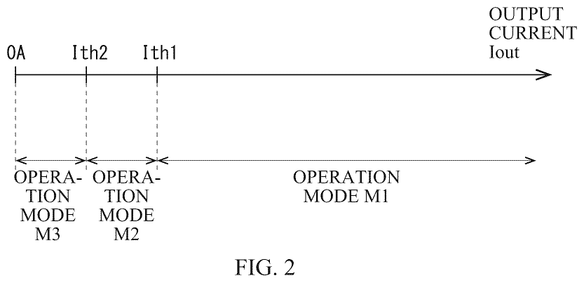

FIG. 2 illustrates an example of operation modes of the electric power conversion apparatus 1. The electric power conversion apparatus 1 may have three operation modes M1 to M3. The control circuit 30 may set the operation mode of the electric power conversion apparatus 1 to any one of the three operation modes corresponding to the output current Iout, based on the current ILr.

For example, when the output current Iout is greater than a threshold Ith1, the control circuit 30 may set the operation mode of the electric power conversion apparatus 1 to the operation mode M1. When the output current Iout is less than or equal to the threshold Ith1 and greater than a threshold Ith2, the control circuit 30 may set the operation mode of the electric power conversion apparatus 1 to the operation mode M2. When the output current Iout is less than or equal to the threshold Ith2, the control circuit 30 may set the operation mode of the electric power conversion apparatus 1 to the operation mode M3. The operation modes M1 to M3 will be described in detail below.

### Operation Mode M1

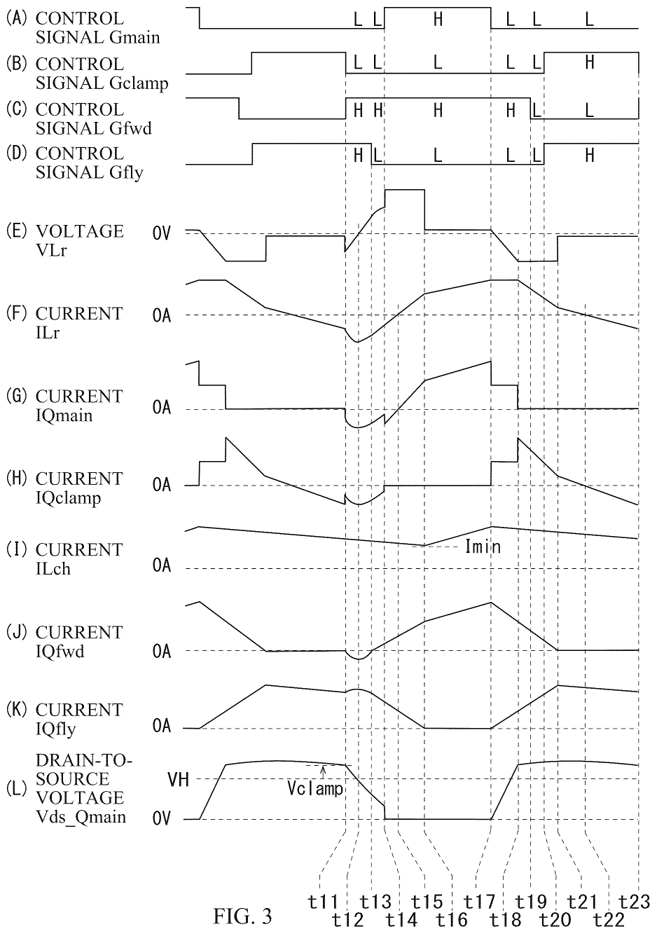

FIG. 3 illustrates an operation example of the electric power conversion apparatus 1 in the operation mode M1. In FIG. 3, part (A) illustrates a waveform of the control signal Gmain, part (B) illustrates a waveform of the control signal Gclamp, part (C) illustrates a waveform of the control signal Gfwd, part (D) illustrates a waveform of the control signal Gfly, part (E) illustrates a waveform of a voltage VLr across the inductor 14, part (F) illustrates a waveform of the current ILr, part (G) illustrates a waveform of a current IQmain flowing through the transistor Qmain, part (H) illustrates a waveform of a current IQclamp flowing through the transistor Qclamp, part (I) illustrates a waveform of a current ILch flowing through the inductor 19, part (J) illustrates a waveform of a current IQfwd flowing through the transistor Qfwd, part (K) illustrates a waveform of a current IQfly flowing through the transistor Qfly, and part (L) illustrates a waveform of a drain-to-source voltage Vds_Qmain of the transistor Qmain. The voltage VLr is a voltage at the voltage line L11B with respect to a voltage at the first end of the winding 16A of the transformer 16. The current IQmain is a current that is assumed to be positive when it flows from the drain toward the source of the transistor Qmain. The current IQclamp is a current that is assumed to be positive when it flows from the source toward the drain of the transistor Qclamp. The current IQfwd is a current that is assumed to be positive when it flows from the source toward the drain of the transistor Qfwd. The current IQfly is a current that is assumed to be positive when it flows from the source toward the drain of the transistor Qfly. In each of parts (A) to (D) of FIG. 3, “H” indicates that a relevant signal is at a high level, and “L” indicates that the relevant signal is at a low level.

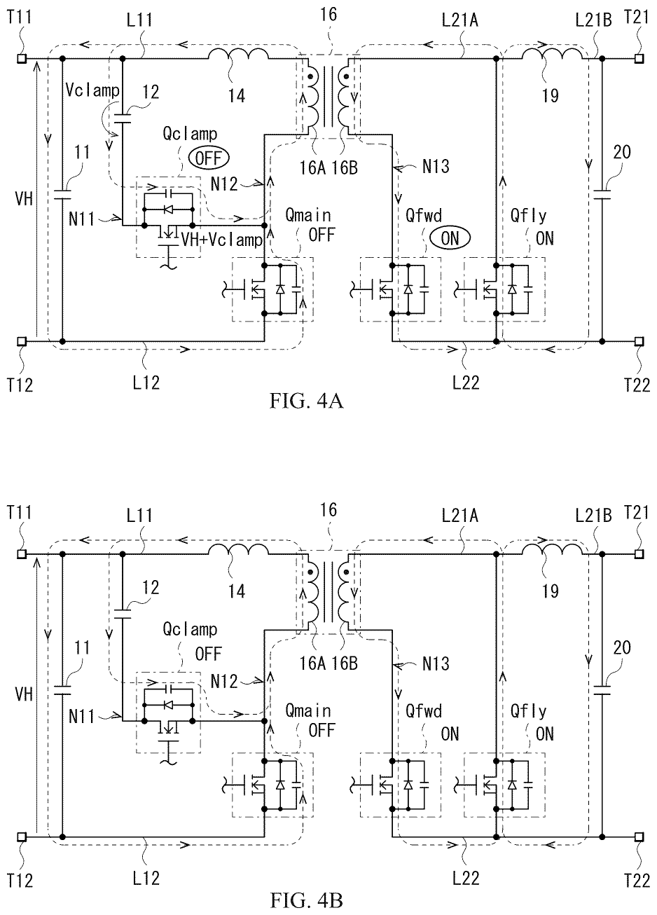

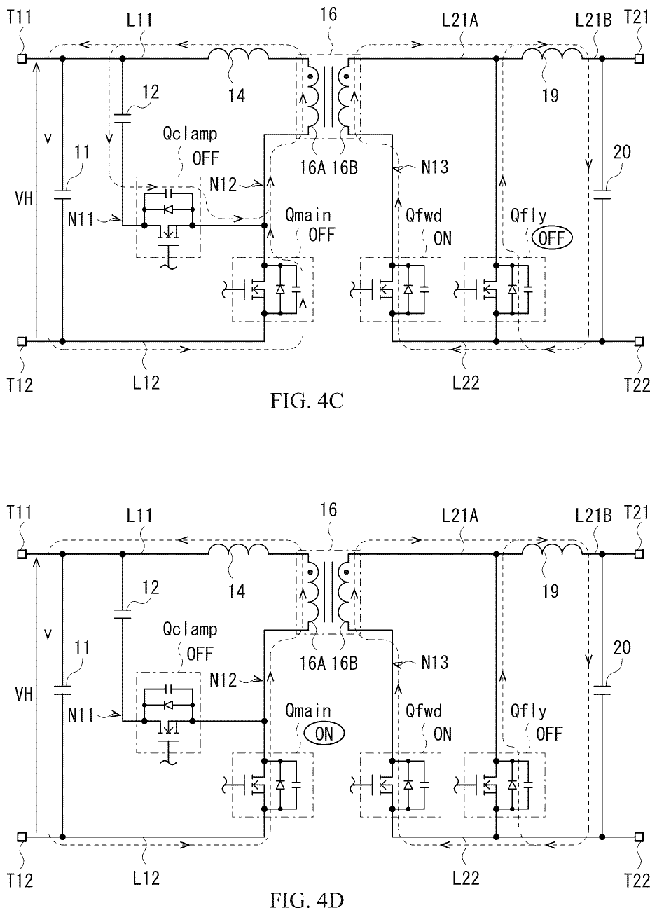

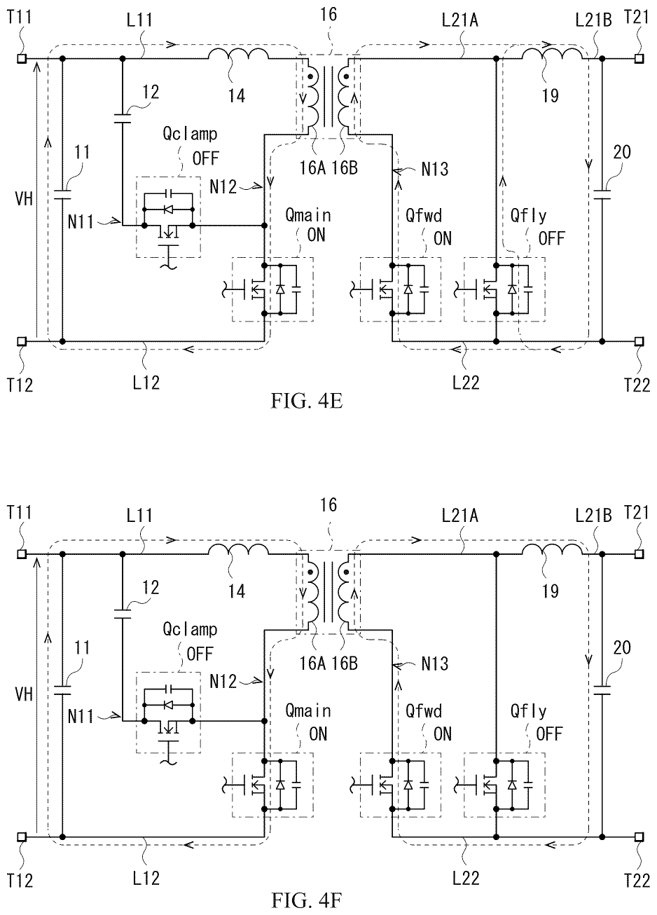

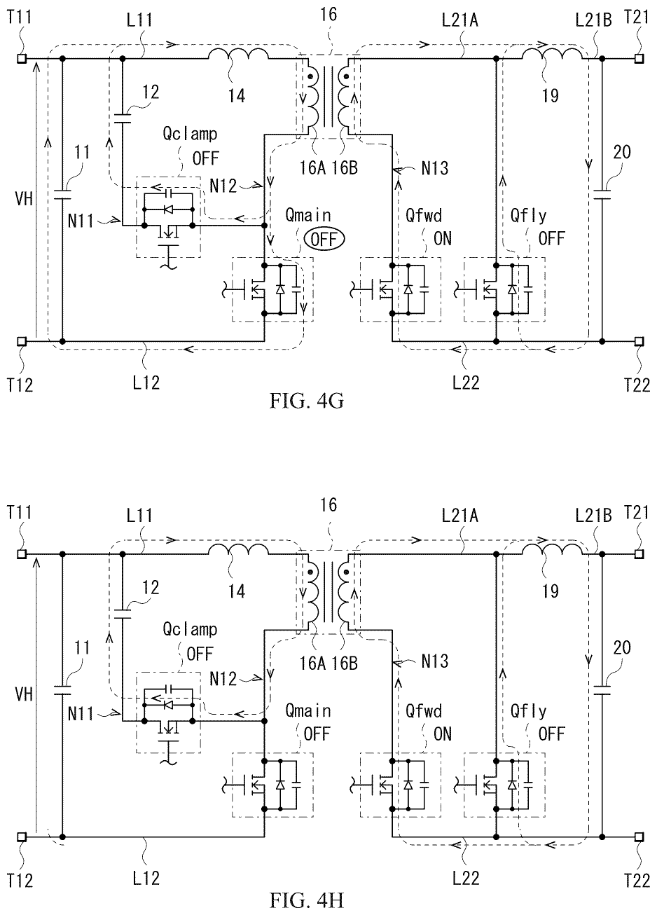

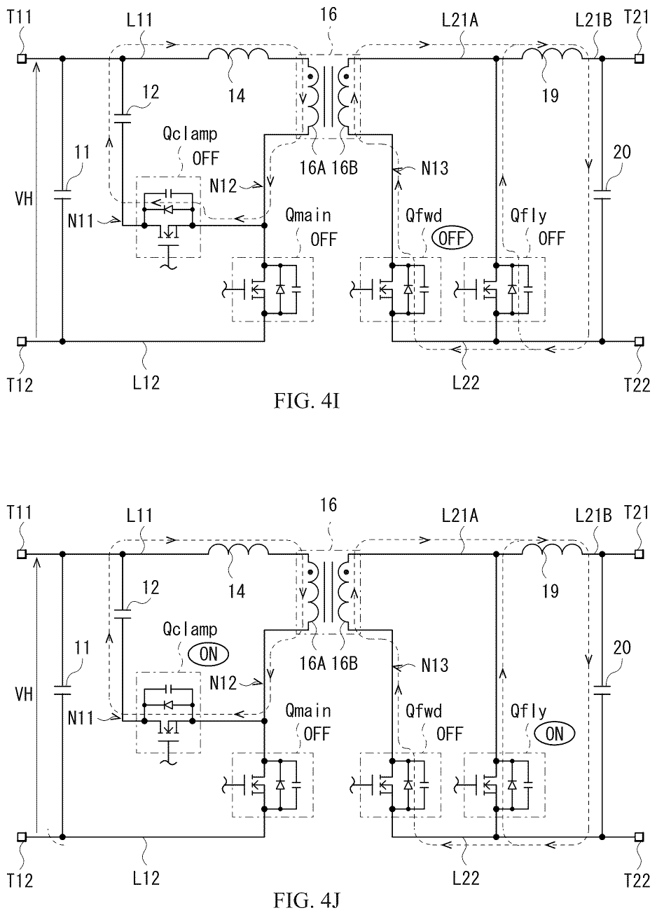

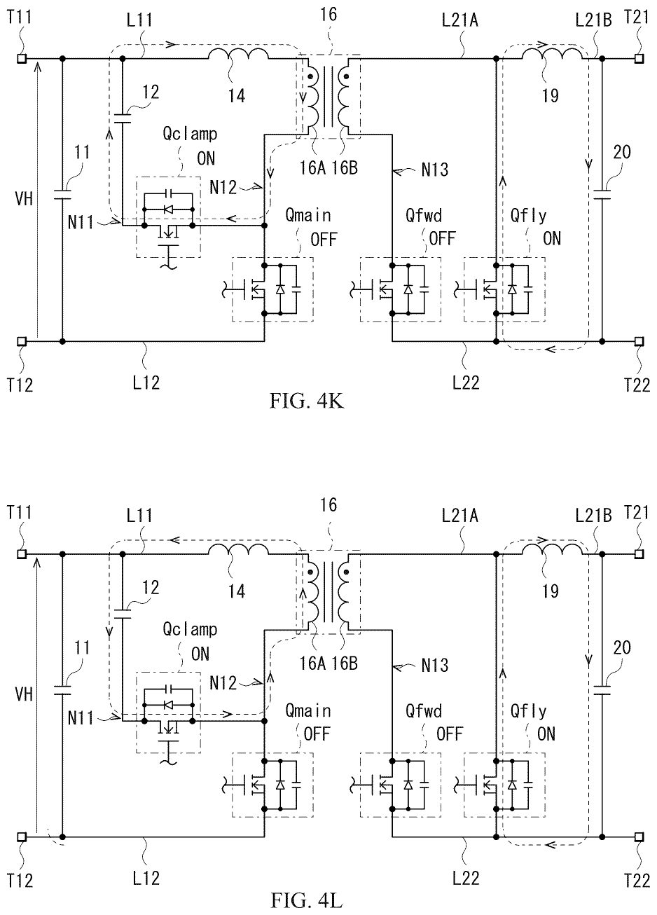

FIGS. 4A to 4L illustrate operation states of the electric power conversion apparatus 1 during various time periods in FIG. 3. For convenience of description, circuits are illustrated in a simplified manner in FIGS. 4A to 4L. Further, for convenience of description, the voltage lines L11A and L11B in FIG. 1 are depicted as a voltage line L11 in FIGS. 4A to 4L. FIGS. 4A to 4L further indicate whether the transistors Qmain, Qclamp, Qfwd, and Qfly are each on or off. In FIGS. 4A to 4L, “ON” is encircled to indicate a state immediately after a change of the transistor Qmain, Qclamp, Qfwd, or Qfly from off to on, and “OFF” is encircled to indicate a state immediately after a change of the transistor Qmain, Qclamp, Qfwd, or Qfly from on to off.

At a timing t11, the control circuit 30 may change the control signal Gclamp from the high level to the low level, and change the control signal Gfwd from the low level to the high level, as illustrated in parts (B) and (C) of FIG. 3. This may cause the transistor Qclamp to change from on to off, and cause the transistor Qfwd to change from off to on, as illustrated in FIG. 4A. The transistor Qmain may be off, and the transistor Qfly may be on. At the timing t11, the drain-to-source voltage Vds_Qmain of the transistor Qmain may be a voltage (VH+Vclamp) corresponding to a sum of the voltage VH at the terminals T11 and T12 and a voltage Vclamp of the capacitor 12, as illustrated in part (L) of FIG. 3 and FIG. 4A. Accordingly, at the timing t11, a voltage at the node N12 may be higher than a voltage at the voltage line L11. During a time period from the timing t11 to a timing t12, current may flow through the primary-side circuitry of the electric power conversion apparatus 1 as illustrated in FIG. 4A. Through the winding 16A of the transformer 16, current may flow in a direction from the node N12 toward the inductor 14. An absolute value of this current (the current ILr) may increase, as illustrated in part (F) of FIG. 3. Through the transistor Qmain, current may flow from the source toward the drain via the parasitic capacitor. As a result, the parasitic capacitor of the transistor Qmain may be gradually discharged, which may cause the drain-to-source voltage Vds_Qmain to drop, as illustrated in part (L) of FIG. 3. Further, current may flow through the secondary-side circuity of the electric power conversion apparatus 1 as illustrated in FIG. 4A.

Thereafter, at the timing t12, the voltage VL may change in polarity from negative to positive, as illustrated in part (E) of FIG. 3. This may cause the voltage at the first end of the winding 16A of the transformer 16 to become lower than the voltage at the voltage line L11B. During a time period from the timing t12 to a timing t13, as illustrated in FIG. 4B, current may flow through each of the primary-side circuity and the secondary-side circuitry of the electric power conversion apparatus 1 along the same path as that during the previous time period. Respective absolute values of the currents ILr, IQmain, and IQclamp in the primary-side circuitry may start to decrease, as illustrated in parts (F), (G), and (H) of FIG. 3, and respective absolute values of the currents IQfwd and IQfly in the secondary-side circuitry may start to decrease, as illustrated in parts (J) and (K) of FIG. 3. The drain-to-source voltage Vds_Qmain may continue to drop, and may fall below the voltage VH at a certain timing in a time period from the timing t11 to the timing t13, as illustrated in part (L) of FIG. 3.

Thereafter, at the timing t13, the control circuit 30 may change the control signal Gfly from the high level to the low level, as illustrated in part (D) of FIG. 3. This may cause the transistor Qfly to change from on to off, as illustrated in FIG. 4C. During a time period from the timing t13 to a timing t14, current may flow through the secondary-side circuitry of the electric power conversion apparatus 1 as illustrated in FIG. 4C. Further, as illustrated in FIG. 4C, current may flow through the primary-side circuitry of the electric power conversion apparatus 1 along the same path as that during the previous time period.

Thereafter, at the timing t14, the control circuit 30 may change the control signal Gmain from the low level to the high level, as illustrated in part (A) of FIG. 3. This may cause the transistor Qmain to change from off to on, as illustrated in FIG. 4D. Due to the transistor Qmain turning on, the drain-to-source voltage Vds_Qmain may become 0 V, as illustrated in part (L) of FIG. 3. During a time period from the timing t14 to a timing t15, current may flow through the primary-side circuitry of the electric power conversion apparatus 1 as illustrated in FIG. 4D. Further, as illustrated in FIG. 4D, current may flow through the secondary-side circuitry of the electric power conversion apparatus 1 along the same path as that during the previous time period.

Thereafter, at the timing t15, the currents ILr and IQmain may change in polarity from negative to positive, as illustrated in parts (F) and (G) of FIG. 3. Accordingly, during a time period from the timing t15 to a timing t16, current may flow through the primary-side circuitry of the electric power conversion apparatus 1 as illustrated in FIG. 4E. Through the winding 16A of the transformer 16, current may flow in a direction from the inductor 14 toward the node N12. Further, as illustrated in FIG. 4E, current may flow through the secondary-side circuitry of the electric power conversion apparatus 1 along the same path as that during the previous time period.

Thereafter, at the timing t16, the current IQfly in the secondary-side circuitry becomes 0 A, as illustrated in part (K) of FIG. 3. Accordingly, during a time period from the timing t16 to a timing t17, current may flow through the secondary-side circuitry of the electric power conversion apparatus 1 as illustrated in FIG. 4F. The current ILch in the secondary-side circuitry may start to increase, as illustrated in part (I) of FIG. 3. Further, as illustrated in FIG. 4F, current may flow through the primary-side circuitry of the electric power conversion apparatus 1 along the same path as that during the previous time period.

Thereafter, at the timing t17, the control circuit 30 may change the control signal Gmain from the high level to the low level, as illustrated in part (A) of FIG. 3. This may cause the transistor Qmain to change from on to off, as illustrated in FIG. 4G. Accordingly, during a time period from the timing t17 to a timing t18, current may flow through the primary-side circuitry of the electric power conversion apparatus 1 as illustrated in FIG. 4G. Through the transistor Qmain, current may flow from the drain toward the source via the parasitic capacitor. As a result, the parasitic capacitor of the transistor Qmain may be gradually charged, which may cause the drain-to-source voltage Vds_Qmain to rise, as illustrated in part (L) of FIG. 3. Further, current may flow through the secondary-side circuity of the electric power conversion apparatus 1 as illustrated in FIG. 4G. In the secondary-side circuitry, the absolute value of the current IQfwd may start to decrease, and the absolute value of the current IQfly may start to increase from 0 A, as illustrated in parts (J) and (K) of FIG. 3.

Thereafter, at the timing t18, the charging of the parasitic capacitor of the transistor Qmain may end, and accordingly, the voltage at the node N12 may become higher than the voltage at the voltage line L11. During a time period from the timing t18 to a timing t19, current may flow through the primary-side circuitry of the electric power conversion apparatus 1 as illustrated in FIG. 4H. Due to the charging of the parasitic capacitor of the transistor Qmain having ended, no current may flow through the transistor Qmain, as illustrated in part (G) of FIG. 3. The absolute value of the current ILr in the primary-side circuitry may start to decrease, as illustrated in part (F) of FIG. 3. Further, as illustrated in FIG. 4H, current may flow through the secondary-side circuitry of the electric power conversion apparatus 1 along the same path as that during the previous time period.

Thereafter, at the timing t19, the control circuit 30 may change the control signal Gfwd from the high level to the low level, as illustrated in part (C) of FIG. 3. This may cause the transistor Qfwd to change from on to off, as illustrated in FIG. 4I. During a time period from the timing t19 to a timing t20, current may flow through the secondary-side circuitry of the electric power conversion apparatus 1 as illustrated in FIG. 4I. Further, as illustrated in FIG. 4I, current may flow through the primary-side circuity of the electric power conversion apparatus 1 along the same path as that during the previous time period.

Thereafter, at the timing t20, the control circuit 30 may change the control signals Gclamp and Gfly from the low level to the high level, as illustrated in parts (B) and (D) of FIG. 3. This may cause the transistors Qclamp and Qfly to change from off to on, as illustrated in FIG. 4J. Accordingly, during a time period from the timing t20 to a timing t21, current may flow through each of the primary-side circuity and the secondary-side circuitry of the electric power conversion apparatus 1 as illustrated in FIG. 4J.

Thereafter, at the timing t21, the current IQfwd in the secondary-side circuitry may become 0 A, as illustrated in part (J) of FIG. 3. During a time period from the timing t21 to a timing t22, current may flow through the secondary-side circuitry of the electric power conversion apparatus 1 as illustrated in FIG. 4K. In the secondary-side circuitry, the absolute value of the current IQfly may start to decrease, as illustrated in part (K) of FIG. 3. Further, as illustrated in FIG. 4K, current may flow through the primary-side circuity of the electric power conversion apparatus 1 along the same path as that during the previous time period.

Thereafter, at the timing t22, the currents ILr and IQclamp in the primary-side circuitry may change in polarity from positive to negative, as illustrated in parts (F) and (H) of FIG. 3. Accordingly, during a time period from the timing t22 to a timing t23, current may flow through the primary-side circuitry of the electric power conversion apparatus 1 as illustrated in FIG. 4L. Through the winding 16A of the transformer 16, current may flow in the direction from the node N12 toward the inductor 14. Further, as illustrated in FIG. 4L, current may flow through the secondary-side circuitry of the electric power conversion apparatus 1 along the same path as that during the previous time period.

Thereafter, at the timing t23, the control circuit 30 may change the control signal Gclamp from the high level to the low level, and change the control signal Gfwd from the low level to the high level, as illustrated in parts (B) and (C) of FIG. 3. This operation is the same as the operation performed at the timing t11.

In the operation mode M1, the electric power conversion apparatus 1 may repeat the foregoing operations performed from the timing t11 to the timing t23.

Here, the control according to the operation mode M1 may correspond to a specific but non-limiting example of “first control” in one embodiment of the disclosure. The operation from the timing t19 to the timing t20 may correspond to a specific but non-limiting example of a “first operation” in one embodiment of the disclosure. The operation from the timing t20 to the timing t23 may correspond to a specific but non-limiting example of a “second operation” in one embodiment of the disclosure. The operation from the timing t11 to the timing t13 may correspond to a specific but non-limiting example of a “third operation” in one embodiment of the disclosure. The operation from the timing t13 to the timing t14 may correspond to a specific but non-limiting example of a “fourth operation” in one embodiment of the disclosure. The operation from the timing t14 to the timing t17 may correspond to a specific but non-limiting example of a “fifth operation” in one embodiment of the disclosure. The operation from the timing t17 to the timing t19 may correspond to a specific but non-limiting example of a “sixth operation” in one embodiment of the disclosure.

### Operation Mode M2

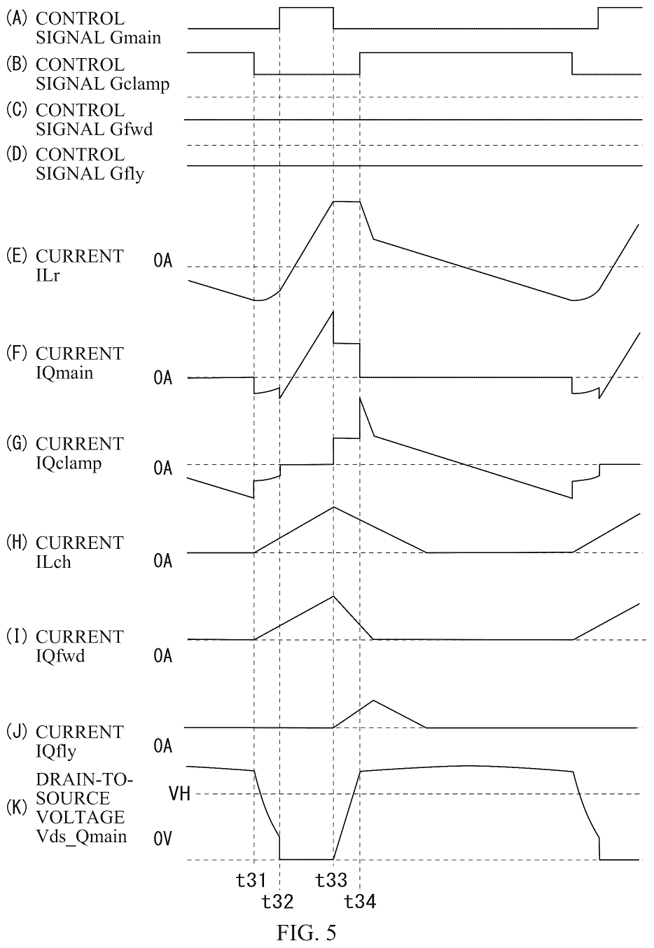

FIG. 5 illustrates an operation example of the electric power conversion apparatus 1 in the operation mode M2. In FIG. 5, part (A) illustrates the waveform of the control signal Gmain, part (B) illustrates the waveform of the control signal Gclamp, part (C) illustrates the waveform of the control signal Gfwd, part (D) illustrates the waveform of the control signal Gfly, part (E) illustrates the waveform of the current ILr, part (F) illustrates the waveform of the current IQmain flowing through the transistor Qmain, part (G) illustrates the waveform of the current IQclamp flowing through the transistor Qclamp, part (H) illustrates the waveform of the current ILch flowing through the inductor 19, part (I) illustrates the waveform of the current IQfwd flowing through the transistor Qfwd, part (J) illustrates the waveform of the current IQfly flowing through the transistor Qfly, and part (K) illustrates the waveform of the drain-to-source voltage Vds_Qmain of the transistor Qmain.

In the operation mode M2, the control circuit 30 may change the control signal Gclamp from the high level to the low level at a timing t31, change the control signal Gmain from the low level to the high level at a timing t32, change the control signal Gmain from the high level to the low level at a timing t33, and change the control signal Gclamp from the low level to the high level at a timing t34, as illustrated in parts (A) and (B) of FIG. 5.

In the operation mode M2, the control circuit 30 may maintain the control signals Gfwd and Gfly at the low level, as illustrated in part (C) and (D) of FIG. 5. This may cause the transistors Qfwd and Qfly to remain off. In this case, in each of the transistors Qfwd and Qfly, current may flow via the body diode and the parasitic capacitor. In other words, in the operation mode M2, the rectifying circuit 17 may refrain from performing the switching operations and may operate as a diode rectifying circuit, unlike in the operation mode M1.

### Operation Mode M3

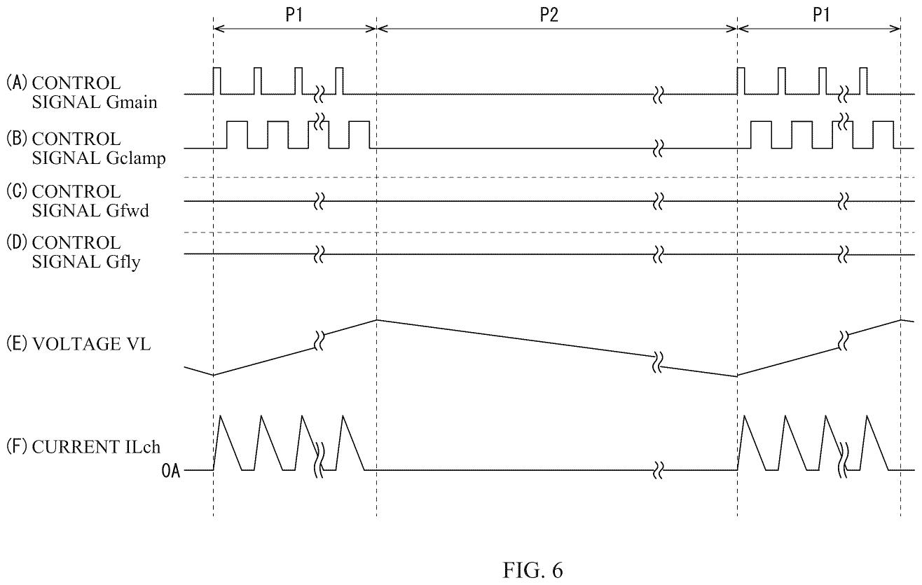

FIG. 6 illustrates an operation example of the electric power conversion apparatus 1 in the operation mode M3. In FIG. 5, part (A) illustrates the waveform of the control signal Gmain, part (B) illustrates the waveform of the control signal Gclamp, part (C) illustrates the waveform of the control signal Gfwd, part (D) illustrates the waveform of the control signal Gfly, part (E) illustrates the waveform of the voltage VL, and part (F) illustrates the waveform of the current ILch flowing through the inductor 19.

In the operation mode M3, the control circuit 30 may intermittently perform the operations to be performed in the operation mode M2. For example, during a time period P1, the control circuit 30 may control the electric power conversion apparatus 1 to perform operations similar to those in the operation mode M2. This may cause the voltage VL to rise, as illustrated in part (E) of FIG. 6. Thereafter, during a time period P2, the control circuit 30 may maintain the control signals Gmain, Gclamp, Gfwd, and Gfly at the low level. This may cause the voltage VL to drop, as illustrated in part (E) of FIG. 6. The control circuit 30 may repeatedly alternate the operation of the time period P1 and the operation of the time period P2.

In such a manner, the control circuit 30 may set the operation mode of the electric power conversion apparatus 1 to any one of the operation modes M1 to M3 described above. For example, as illustrated in FIG. 2, the control circuit 30 may set the operation mode of the electric power conversion apparatus 1 to the operation mode M1 when the output current Iout is greater than the threshold Ith1. The control circuit 30 may set the operation mode of the electric power conversion apparatus 1 to the operation mode M2 when the output current Iout is less than or equal to the threshold Ith1 and greater than the threshold Ith2. The control circuit 30 may set the operation mode of the electric power conversion apparatus 1 to the operation mode M3 when the output current Iout is less than or equal to the threshold Ith2.

For example, the threshold Ith1 may be set for the output current Iout that allows, in the operation mode M1, a lowest current value Imin of the current ILch illustrated in part (I) of FIG. 3 to be 0 A.

The threshold Ith2 may be set for the output current Iout that allows, in the operation mode M2, a duty ratio of the control signal Gmain to be equal to a lower limit of the duty ratio of the control signal Gmain that the control circuit 30 can generate. For example, in the operation mode M2, the smaller the output current Iout is, the lower the duty ratio of the control signal Gmain can be. Because an excessively low duty ratio of the control signal Gmain results in an excessively narrow pulse width of the control signal Gmain, a lower limit is defined for the duty ratio of the control signal Gmain and the control circuit 30 is not allowed to select a duty ratio below the lower limit. The threshold Ith2 may be set for the output current Iout that allows the duty ratio of the control signal Gmain to be equal to such a lower limit.

### Reference Examples

Workings of the present disclosure will now be described in comparison with some reference examples.

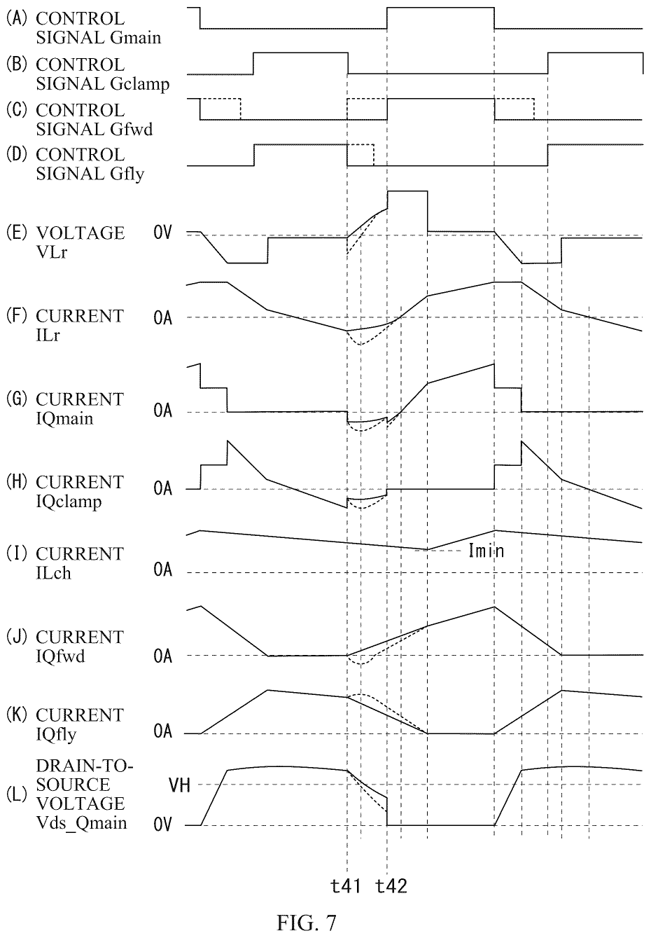

FIG. 7 illustrates an example of operation of an electric power conversion apparatus 1R according to a reference example in the operation mode M1. For convenience of description, in FIG. 7, the waveforms obtainable with the electric power conversion apparatus 1 according to the first example embodiment (FIG. 3) are illustrated in dashed lines.

In this example, the control circuit 30 may change the control signals Gclamp and Gfly from the high level to the low level at a timing t41, and may change the control signals Gmain and Gfwd from the low level to the high level at a timing t42, as illustrated in parts (A) to (D) of FIG. 7. During a time period from the timing t41 to the timing t42, the drain-to-source voltage Vds_Qmain of the transistor Qmain may drop. It is desirable that the drain-to-source voltage Vds_Qmain be low at the timing t42 at which the transistor Qmain changes from off to on based on the control signal Gmain; however, in the electric power conversion apparatus 1R, the drain-to-source voltage Vds_Qmain can be relatively high at the timing t42. As a result, the electric power conversion apparatus 1R can suffer an increase in turn-on loss.

For example, in the electric power conversion apparatus 1R, an inductance of the inductor 14 may be increased to reduce the drain-to-source voltage Vds_Qmain of the transistor Qmain at the timing t42. This, however, leads to an increase in size of the inductor 14, and can thus result in an increase in cost of the electric power conversion apparatus 1R. As another possible approach, in the electric power conversion apparatus 1R, for example, an excitation current of the transformer 16 may be increased to reduce the drain-to-source voltage Vds_Qmain of the transistor Qmain at the timing t42. This, however, can result in decreased efficiency.

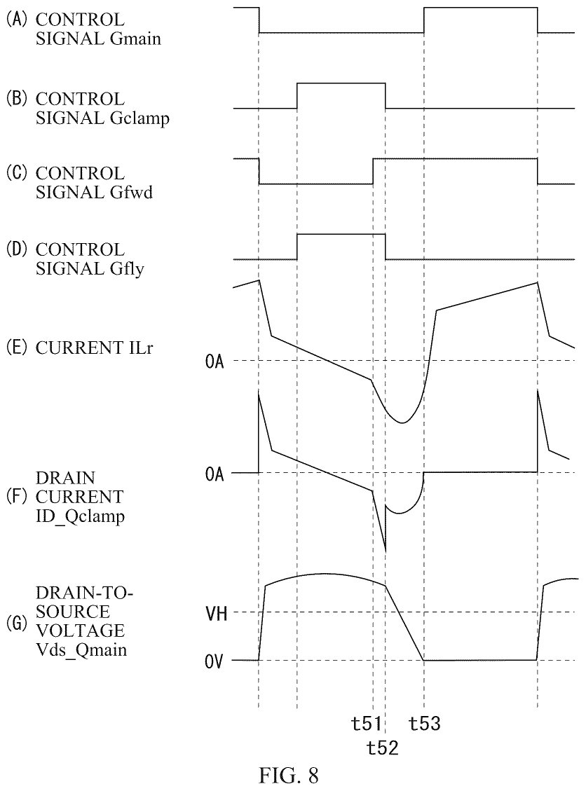

FIG. 8 illustrates an example of operation of an electric power conversion apparatus 1S according to another reference example in the operation mode M1. In FIG. 8, part (A) illustrates the waveform of the control signal Gmain, part (B) illustrates the waveform of the control signal Gclamp, part (C) illustrates the waveform of the control signal Gfwd, part (D) illustrates the waveform of the control signal Gfly, part (E) illustrates the waveform of the current ILr, part (F) illustrates a waveform of a drain current ID_Qclamp of the transistor Qclamp, and part (G) illustrates the waveform of the drain-to-source voltage Vds_Qmain of the transistor Qmain. The electric power conversion apparatus 1S is based on a technique disclosed in International Publication No. WO 2004/001937.

In this example, the control circuit 30 may change the control signal Gfwd from the low level to the high level at a timing t51, change the control signals Gclamp and Gfly from the high level to the low level at a timing t52, and change the control signal Gmain from the low level to the high level at a timing t53, as illustrated in parts (A) to (D) of FIG. 8. In this example, the transistors Qclamp, Qfwd, and Qfly may all be on during a time period from the timing t51 to the timing t52. This allows for an increase in current flowing through a leakage inductance of the transformer 16, and this current may be used for charging and discharging of the parasitic capacitors of the transistors Qmain and Qclamp to thereby reduce the turn-on loss of the transistor Qmain.

In this case, however, as illustrated in part (F) of FIG. 8, the current flowing through the transistor Qclamp can suddenly increase immediately before the timing t52. This may make it necessary to take measures against noise. Further, such an increase in the current flowing through the transistor Qclamp would result in a large conduction loss. Moreover, the turning-off of the transistor Qclamp at the timing t52 in the state where a large current is flowing through the transistor Qclamp would result in a large turn-off loss.

In contrast, in the electric power conversion apparatus 1 according to the first example embodiment, as illustrated in FIG. 3, the control circuit 30 may change the control signal Gclamp from the high level to the low level and the control signal Gfwd from the low level to the high level at the timing t11, thereafter change the control signal Gfly from the high level to the low level at the timing t13, and thereafter change the control signal Gmain from the low level to the high level at the timing t14. In other words, the control circuit 30 may allow both the control signal Gfwd and the control signal Gfly to be at the high level during the time period from the timing t11 to the timing t13 that is after the change of the control signal Gclamp from the high level to the low level. As a result, during the time period from the timing t11 to the timing t13, both ends of the winding 16B of the transformer 16 may be short-circuited via the transistors Qfwd and Qfly that are on. During this time period, in the primary-side circuitry, the current ILr may be allowed to flow through the inductor 14 (part (F) of FIG. 3) using energy stored in the parasitic capacitor of the transistor Qmain. This helps to avoid the flow of a large current through the transistor Qclamp. In addition, owing to the drop in the drain-to-source voltage Vds_Qmain, the absolute value of the current ILr may decrease during the time period from the timing t12 to the timing t13. In such a manner, the electric power conversion apparatus 1 helps to allow the drain-to-source voltage Vds_Qmain to be low to some extent at the timing t14 at which the transistor Qmain changes from off to on. This helps to reduce the turn-on loss of the transistor Qmain. Further, owing to no large current flowing through the transistor Qclamp, the electric power conversion apparatus 1 helps to reduce conduction loss, and helps to reduce the turn-off loss of the transistor Qclamp. As a result, the electric power conversion apparatus 1 helps to reduce energy loss.

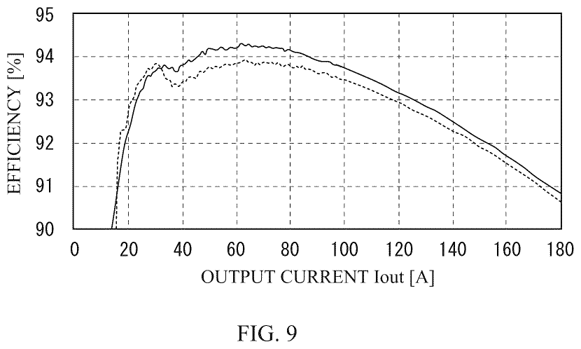

FIG. 9 illustrates a characteristic example of efficiency characteristics. In FIG. 9, a solid line represents an efficiency characteristic of the electric power conversion apparatus 1 according to the first example embodiment, and a dashed line represents an efficiency characteristic of the electric power conversion apparatus 1R according to the reference example. Further, in FIG. 9, a horizontal axis represents the output current Iout, and a vertical axis represents efficiency. As compared with the electric power conversion apparatus 1R according to the reference example, the electric power conversion apparatus 1 according to the first example embodiment allows for increased efficiency when the output current Iout is 30 A or above.

As has been described, the electric power conversion apparatus 1 includes the first electric power terminal (the terminals T11 and T12), the inductor 14, the capacitor 12, the switching circuit 15, the transformer 16, the rectifying circuit 17, the smoothing circuit 18, the second electric power terminal (T21 and T22), and the control circuit 30. The first electric power terminal (the terminals T11 and T12) includes the first coupling terminal (the terminal T11) and the second coupling terminal (the terminal T12). The inductor 14 has the first end coupled to the first coupling terminal (the terminal T11) and the second end coupled to a first node. The capacitor 12 has the first end coupled to the first coupling terminal (the terminal T11) and the second end coupled to a second node (the node N11). The switching circuit 15 includes the first switching device (the transistor Qmain) and the second switching device (the transistor Qclamp). The first switching device (the transistor Qmain) has a first end coupled to a third node (the node N12) and a second end coupled to the second coupling terminal (the terminal T12). The second switching device (the transistor Qclamp) has a first end coupled to the second node (the node N11) and a second end coupled to the third node (the node N12). The transformer 16 includes the first winding (the winding 16A) and the second winding (the winding 16B). The first winding (the winding 16A) has the first end coupled to the first node and the second end coupled to the third node (the node N12). The second winding (the winding 16B) has the first end coupled to a fourth node (the voltage line L21A) and the second end coupled to a fifth node (the node N13). The rectifying circuit 17 includes the third switching device (the transistor Qfwd) and the fourth switching device (the transistor Qfly). The third switching device (the transistor Qfwd) has a first end coupled to the fifth node (the node N13) and a second end coupled to a sixth node (the reference voltage line L22). The fourth switching device (the transistor Qfly) has a first end coupled to the fourth node (the voltage line L21A) and a second end coupled to the sixth node (the reference voltage line L22). The smoothing circuit 18 is coupled to the fourth node (the voltage line L21A) and the sixth node (the reference voltage line L22). The second electric power terminal (T21 and T22) is coupled to the smoothing circuit 18. The control circuit 30 is configured to control the operations of the switching circuit 15 and the rectifying circuit 17 by performing the first control (the control in the operation mode M1) in which the first operation, the second operation, the third operation, the fourth operation, the fifth operation, and the sixth operation are performed in this order repeatedly. The first operation (the operation from the timing t19 to the timing t20) includes causing the first switching device (the transistor Qmain), the second switching device (the transistor Qclamp), the third switching device (the transistor Qfwd), and the fourth switching device (the transistor Qfly) to be off. The second operation (the operation from the timing t20 to the timing t23) includes causing the second switching device (the transistor Qclamp) and the fourth switching device (the transistor Qfly) to be on and causing the first switching device (the transistor Qmain) and the third switching device (the transistor Qfwd) to be off. The third operation (the operation from the timing t11 to the timing t13) includes causing the third switching device (the transistor Qfwd) and the fourth switching device (the transistor Qfly) to be on and causing the first switching device (the transistor Qmain) and the second switching device (the transistor Qclamp) to be off. The fourth operation (the operation from the timing t13 to the timing t14) includes causing the third switching device (the transistor Qfwd) to be on and causing the first switching device (the transistor Qmain), the second switching device (the transistor Qclamp), and the fourth switching device (the transistor Qfly) to be off. The fifth operation (the operation from the timing t14 to the timing t17) includes causing the first switching device (the transistor Qmain) and the third switching device (the transistor Qfwd) to be on and causing the second switching device (the transistor Qclamp) and the fourth switching device (the transistor Qfly) to be off. The sixth operation (the operation from the timing t17 to the timing t19) includes causing the third switching device (the transistor Qfwd) to be on and causing the first switching device (the transistor Qmain), the second switching device (the transistor Qclamp), and the fourth switching device (the transistor Qfly) to be off. With such a configuration, the electric power conversion apparatus 1 helps to allow the drain-to-source voltage Vds_Qmain to be low to some extent at the timing t14 at which the transistor Qmain changes from off to on. This helps to reduce the turn-on loss of the transistor Qmain, as described above. Further, the electric power conversion apparatus 1 helps to prevent a large current from flowing through the transistor Qclamp. This helps to reduce conduction loss, and helps to reduce the turn-off loss of the transistor Qclamp. As a result, the electric power conversion apparatus 1 helps to reduce energy loss.

In some embodiments, the electric power conversion apparatus 1 may be configured to, in the time period during which the control circuit 30 is performing the third operation (the time period from the timing t11 to the timing t13), allow a first voltage (the drain-to-source voltage Vds_Qmain) across the first switching device (the transistor Qmain) to change from a voltage higher than a second voltage (the voltage VH) between the first coupling terminal (the terminal T11) and the second coupling terminal (the terminal T12) to a voltage lower than the second voltage (the voltage VH). With such a configuration, the electric power conversion apparatus 1 helps to allow the drain-to-source voltage Vds_Qmain to be low to some extent at the timing t14 at which the transistor Qmain changes from off to on, as described above. As a result, the electric power conversion apparatus 1 helps to reduce energy loss.

### Example Effects

As has been described, an electric power conversion apparatus according to an embodiment of the disclosure includes a first electric power terminal, an inductor, a capacitor, a switching circuit, a transformer, a rectifying circuit, a smoothing circuit, a second electric power terminal, and a control circuit. The first electric power terminal includes a first coupling terminal and a second coupling terminal. The inductor has a first end coupled to the first coupling terminal and a second end coupled to a first node. The capacitor has a first end coupled to the first coupling terminal and a second end coupled to a second node. The switching circuit includes a first switching device and a second switching device. The first switching device has a first end coupled to a third node and a second end coupled to the second coupling terminal. The second switching device has a first end coupled to the second node and a second end coupled to the third node. The transformer includes a first winding and a second winding. The first winding has a first end coupled to the first node and a second end coupled to the third node. The second winding has a first end coupled to a fourth node and a second end coupled to a fifth node. The rectifying circuit includes a third switching device and a fourth switching device. The third switching device has a first end coupled to the fifth node and a second end coupled to a sixth node. The fourth switching device has a first end coupled to the fourth node and a second end coupled to the sixth node. The smoothing circuit is coupled to the fourth node and the sixth node. The second electric power terminal is coupled to the smoothing circuit. The control circuit is configured to control operations of the switching circuit and the rectifying circuit by performing first control in which a first operation, a second operation, a third operation, a fourth operation, a fifth operation, and a sixth operation are performed in this order repeatedly. The first operation includes causing the first switching device, the second switching device, the third switching device, and the fourth switching device to be off. The second operation includes causing the second switching device and the fourth switching device to be on and causing the first switching device and the third switching device to be off. The third operation includes causing the third switching device and the fourth switching device to be on and causing the first switching device and the second switching device to be off. The fourth operation includes causing the third switching device to be on and causing the first switching device, the second switching device, and the fourth switching device to be off. The fifth operation includes causing the first switching device and the third switching device to be on and causing the second switching device and the fourth switching device to be off. The sixth operation includes causing the third switching device to be on and causing the first switching device, the second switching device, and the fourth switching device to be off. This helps to reduce energy loss.

In some embodiments, the electric power conversion apparatus may be configured to, in a time period during which the control circuit is performing the third operation, allow a first voltage across the first switching device to change from a voltage higher than a second voltage between the first coupling terminal and the second coupling terminal to a voltage lower than the second voltage. This helps reduce energy loss.

### 2. Second Example Embodiment

Next, a description will be given of an electric power conversion apparatus 2 according to a second example embodiment. Note that components substantially the same as those in the electric power conversion apparatus 1 according to the foregoing first example embodiment are denoted with the same reference signs and descriptions thereof are omitted where appropriate.

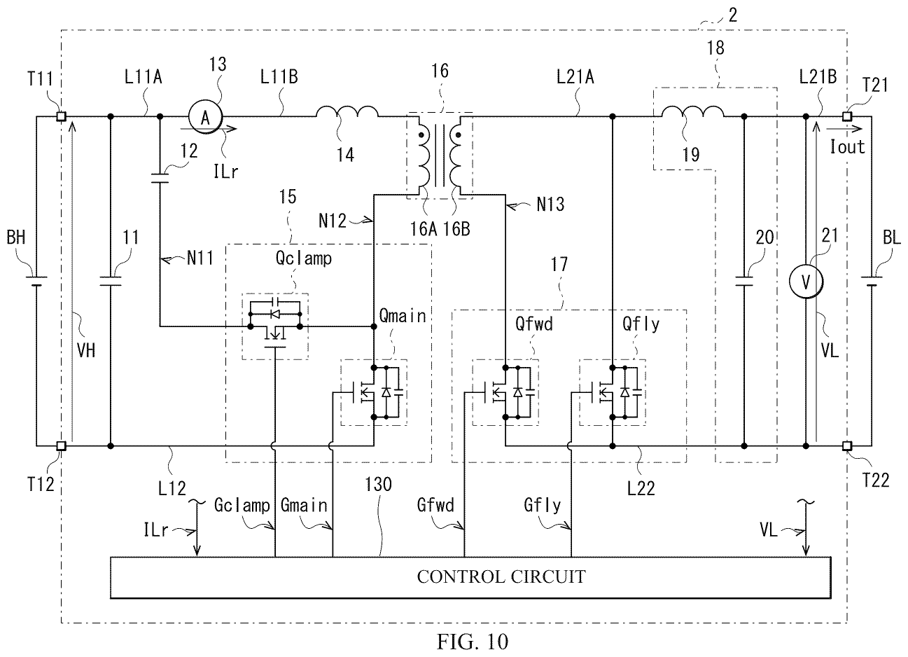

FIG. 10 illustrates a configuration example of the electric power conversion apparatus 2. The electric power conversion apparatus 2 includes a control circuit 130. As with the control circuit 30 according to the foregoing first example embodiment, the control circuit 130 may be configured to control the operation of the electric power conversion apparatus 2, based on the current ILr detected by the current sensor 13 and the voltage VL detected by the voltage sensor 21.

The electric power conversion apparatus 2 may have the operation mode M1 alone. In other words, unlike the control circuit 30 according to the foregoing first example embodiment, the control circuit 130 may perform no switching between operation modes of the electric power conversion apparatus 2. When the output current Iout is large, the electric power conversion apparatus 2 may operate in a manner similar to that in the foregoing first example embodiment. In contrast, when the output current Iout decreases and the lowest current value Imin of the current ILch illustrated in part (H) of FIG. 3 falls below 0 A, the electric power conversion apparatus 2 may operate in the following manner.

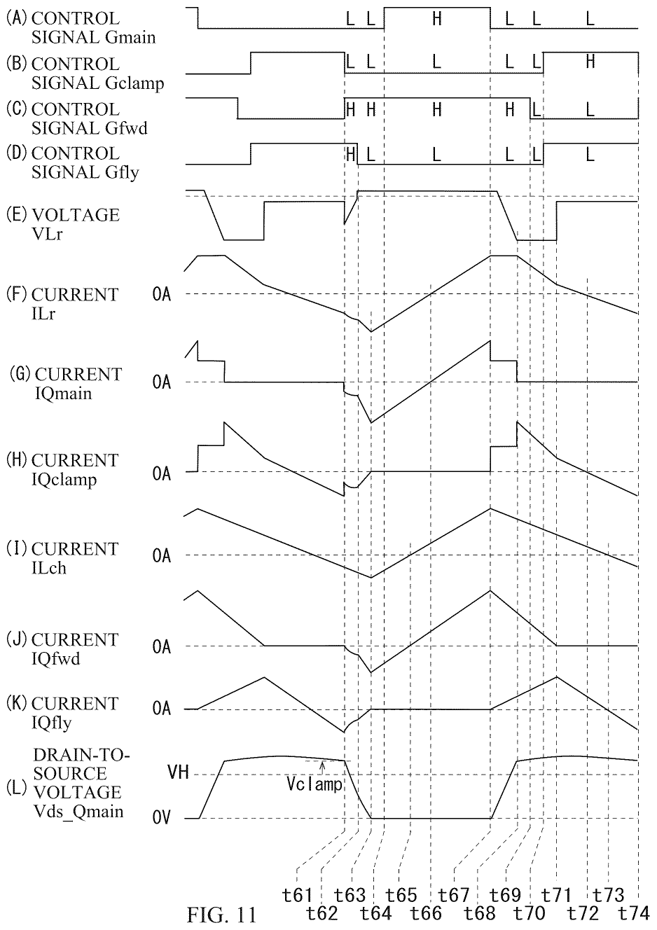

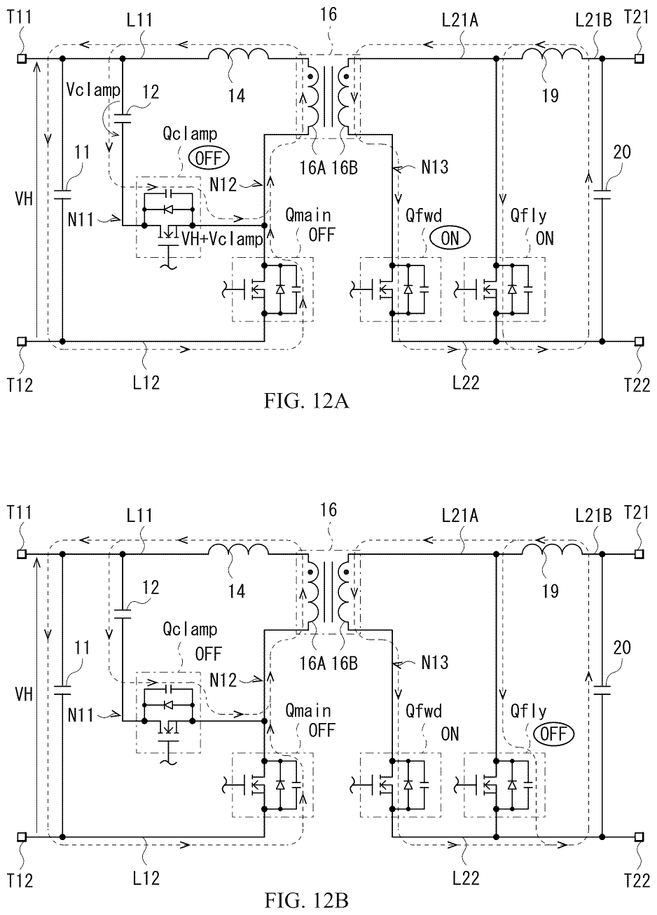

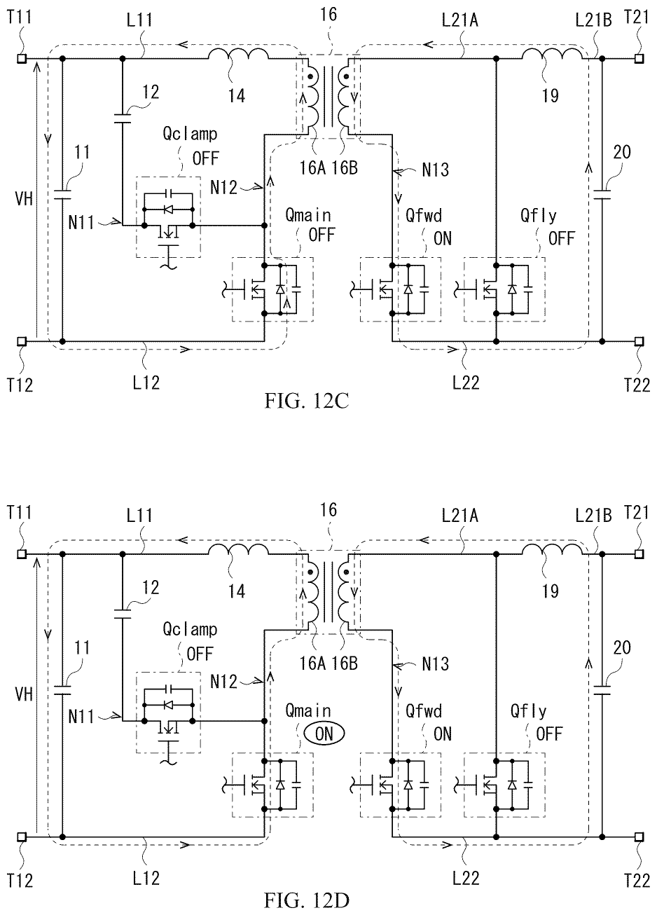

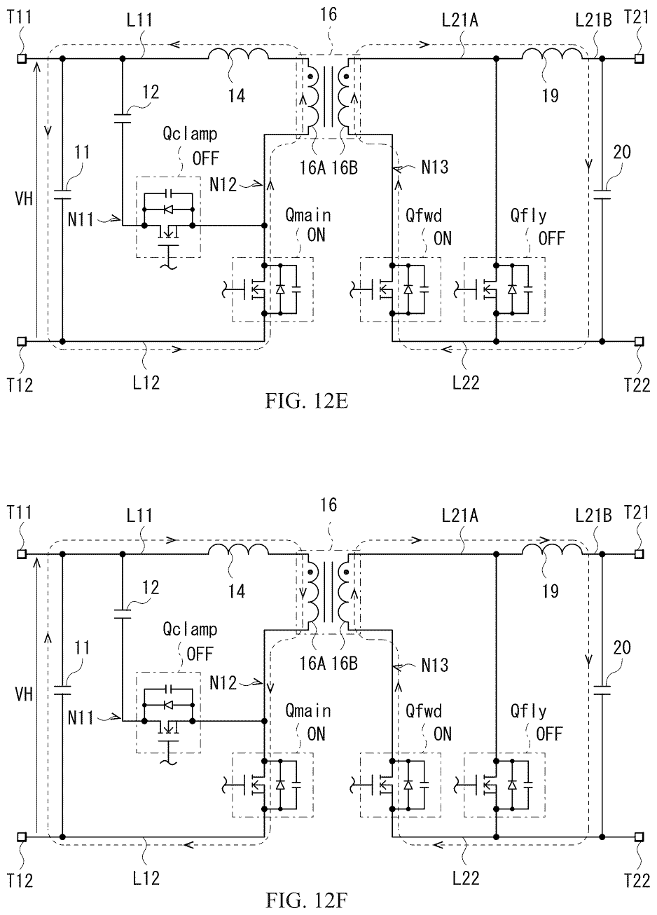

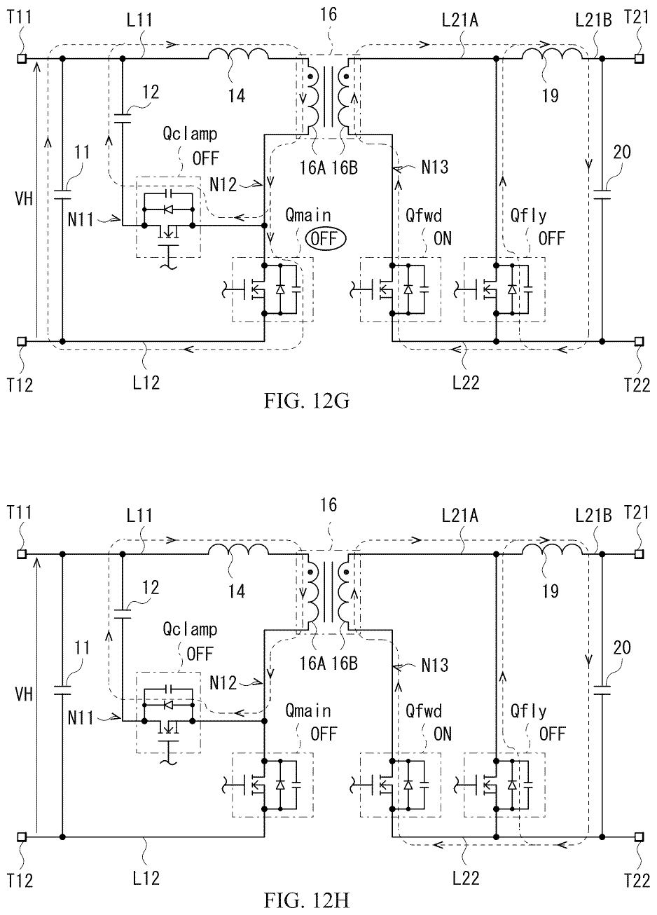

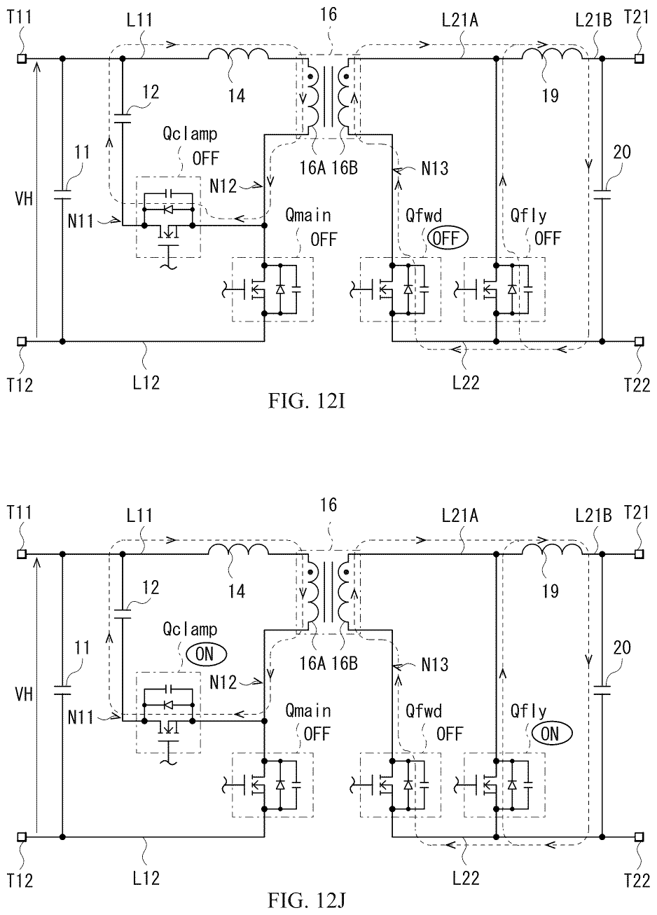

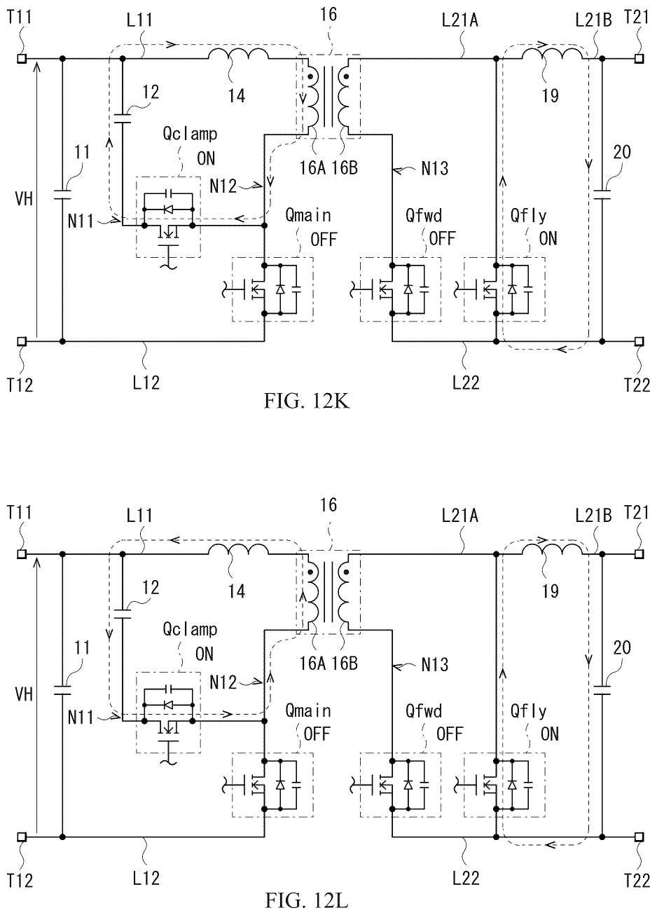

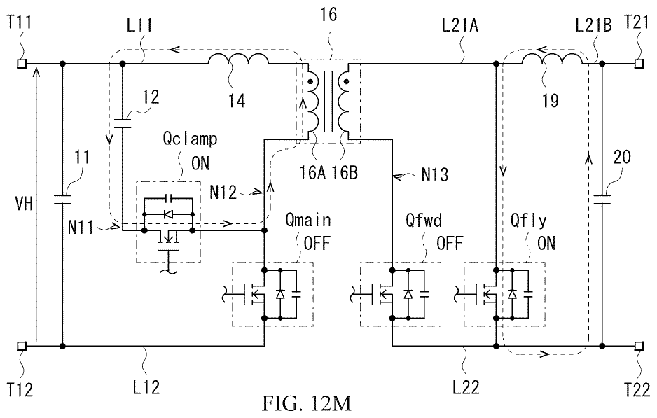

FIG. 11 illustrates an example of operation the electric power conversion apparatus 2 when the output current Iout is small. FIGS. 12A to 12M illustrate operation states of the electric power conversion apparatus 2 during various time periods in FIG. 11. In this operation example, the electric power conversion apparatus 2 may transmit electric power from the primary-side circuitry to the secondary-side circuitry during a time period from a timing t65 to a timing t73 within a time period corresponding to one period, and transmit electric power from the secondary-side circuitry to the primary-side circuitry during other time periods within the time period corresponding to one period.

At a timing t61, the control circuit 130 may change the control signal Gclamp from the high level to the low level, and change the control signal Gfwd from the low level to the high level, as illustrated in parts (B) and (C) of FIG. 11. This may cause the transistor Qclamp to change from on to off, and cause the transistor Qfwd to change from off to on, as illustrated in FIG. 12A. The transistor Qmain may be off, and the transistor Qfly may be on. At the timing t61, the drain-to-source voltage Vds_Qmain of the transistor Qmain may be a voltage (VH+Vclamp) corresponding to the sum of the voltage VH at the terminals T11 and T12 and the voltage Vclamp of the capacitor 12, as illustrated in part (L) of FIG. 11 and FIG. 12A. Accordingly, at the timing t61, the voltage at the node N12 may be higher than the voltage at the voltage line L11. During a time period from the timing t61 to a timing t62, current may flow through the primary-side circuitry of the electric power conversion apparatus 2 as illustrated in FIG. 12A. Through the winding 16A of the transformer 16, current may flow in the direction from the node N12 toward the inductor 14. The absolute value of this current (the current ILr) may increase, as illustrated in part (F) of FIG. 11. Through the transistor Qmain, current may flow from the source toward the drain via the parasitic capacitor. As a result, the parasitic capacitor of the transistor Qmain may be gradually discharged, which may cause the drain-to-source voltage Vds_Qmain to drop, as illustrated in part (L) of FIG. 11. The drain-to-source voltage Vds_Qmain may fall below the voltage VH at a certain timing in the time period from the timing t61 to the timing t62. Further, current may flow through the secondary-side circuity of the electric power conversion apparatus 2 as illustrated in FIG. 12A. Through the inductor 19, the current ILch may flow in a direction from the voltage line L21B toward the voltage line L21A.

Thereafter, at the timing t62, the control circuit 130 may change the control signal Gfly from the high level to the low level, as illustrated in part (D) of FIG. 11. This may cause the transistor Qfly to change from on to off, as illustrated in FIG. 12B. During a time period from the timing t62 to a timing t63, current may flow through the secondary-side circuitry of the electric power conversion apparatus 2 as illustrated in FIG. 12B. Further, as illustrated in FIG. 12B, current may flow through the primary-side circuitry of the electric power conversion apparatus 2 along the same path as that during the previous time period. The drain-to-source voltage Vds_Qmain may continue to drop, as illustrated in part (L) of FIG. 11.

Thereafter, at the timing t63, the drain-to-source voltage Vds_Qmain may become 0 V, as illustrated in part (L) of FIG. 11. During a time period from the timing t63 to a timing t64, current may flow through each of the primary-side circuity and the secondary-side circuitry of the electric power conversion apparatus 2 as illustrated in FIG. 12C. The respective absolute values of the currents ILr and IQmain in the primary-side circuitry may start to decrease, as illustrated in parts (F) and (G) of FIG. 11. Further, in the secondary-side circuitry, the absolute value of the current IQfwd may start to decrease, and the current IQfly may become 0 A, as illustrated in parts (J) and (K) of FIG. 11. At the timing t63, the absolute value of the current ILch in the secondary-side circuitry may change from increasing to decreasing, as illustrated in part (I) of FIG. 11.

Thereafter, at the timing t64, the control circuit 130 may change the control signal Gmain from the low level to the high level, as illustrated in part (A) of FIG. 11. This may cause the transistor Qmain to change from off to on, as illustrated in FIG. 12D. During a time period from the timing t64 to the timing t65, current may flow through the primary-side circuitry of the electric power conversion apparatus 2 as illustrated in FIG. 12D. Further, as illustrated in FIG. 12D, current may flow through the secondary-side circuitry of the electric power conversion apparatus 2 along the same path as that during the previous time period.

Thereafter, at the timing t65, the currents ILch and IQfwd may change in polarity from negative to positive, as illustrated in parts (I) and (J) of FIG. 11. Accordingly, during a time period from the timing t65 to the timing t66, current may flow through the secondary-side circuitry of the electric power conversion apparatus 2 as illustrated in FIG. 12E. Through the inductor 19, the current ILch may flow in a direction from the voltage line L21A toward the voltage line L21B. Further, as illustrated in FIG. 12E, current may flow through the primary-side circuitry of the electric power conversion apparatus 2 along the same path as that during the previous time period.

Thereafter, at the timing t66, the currents ILr and IQmain may change in polarity from negative to positive, as illustrated in parts (F) and (G) of FIG. 11. Accordingly, during a time period from the timing t66 to the timing t67, current may flow through the primary-side circuitry of the electric power conversion apparatus 2 as illustrated in FIG. 12F. Through the winding 16A of the transformer 16, current may flow in the direction from the inductor 14 toward the node N12. Further, as illustrated in FIG. 12F, current may flow through the secondary-side circuitry of the electric power conversion apparatus 2 along the same path as that during the previous time period.

Thereafter, at the timing t67, the control circuit 130 may change the control signal Gmain from the high level to the low level, as illustrated in part (A) of FIG. 11. This may cause the transistor Qmain to change from on to off, as illustrated in FIG. 12G. Accordingly, during a time period from the timing t67 to the timing t68, current may flow through the primary-side circuitry of the electric power conversion apparatus 2 as illustrated in FIG. 12G. Through the transistor Qmain, current may flow from the drain toward the source via the parasitic capacitor. As a result, the parasitic capacitor of the transistor Qmain may be gradually charged, which may cause the drain-to-source voltage Vds_Qmain to rise, as illustrated in part (L) of FIG. 11. Further, current may flow through the secondary-side circuity of the electric power conversion apparatus 2 as illustrated in FIG. 12G. At the timing t67, the absolute value of the current ILch in the secondary-side circuitry may change from increasing to decreasing, as illustrated in part (I) of FIG. 11.

Thereafter, at the timing t68, the charging of the parasitic capacitor of the transistor Qmain may end, and accordingly, the voltage at the node N12 may become higher than the voltage at the voltage line L11. During a time period from the timing t68 to the timing t69, current may flow through the primary-side circuitry of the electric power conversion apparatus 2 as illustrated in FIG. 12H. Due to the charging of the parasitic capacitor of the transistor Qmain having ended, no current may flow through the transistor Qmain, as illustrated in part (G) of FIG. 11. The absolute value of the current ILr in the primary-side circuitry may start to decrease, as illustrated in part (F) of FIG. 11. Further, as illustrated in FIG. 12H, current may flow through the secondary-side circuitry of the electric power conversion apparatus 2 along the same path as that during the previous time period.

Thereafter, at the timing t69, the control circuit 130 may change the control signal Gfwd from the high level to the low level, as illustrated in part (C) of FIG. 11. This may cause the transistor Qfwd to change from on to off, as illustrated in FIG. 12I. During a time period from the timing t69 to the timing t70, current may flow through the secondary-side circuitry of the electric power conversion apparatus 2 as illustrated in FIG. 12I. Further, as illustrated in FIG. 12I, current may flow through the primary-side circuitry of the electric power conversion apparatus 2 along the same path as that during the previous time period.

Thereafter, at the timing t70, the control circuit 130 may change the control signals Gclamp and Gfly from the low level to the high level, as illustrated in parts (B) and (D) of FIG. 11. This may cause the transistors Qclamp and Qfly to change from off to on, as illustrated in FIG. 12J. Accordingly, during a time period from the timing t70 to the timing t71, current may flow through each of the primary-side circuitry and the secondary-side circuitry of the electric power conversion apparatus 2 as illustrated in FIG. 12J.

Thereafter, at the timing t71, the current IQfwd in the secondary-side circuitry may become 0 A, as illustrated in part (J) of FIG. 11. Accordingly, during a time period from the timing t71 to the timing t72, current may flow through the secondary-side circuitry of the electric power conversion apparatus 2 as illustrated in FIG. 12K. In the secondary-side circuitry, the absolute value of the current IQfly may start to decrease, as illustrated in part (K) of FIG. 11. Further, as illustrated in FIG. 12K, current may flow through the primary-side circuitry of the electric power conversion apparatus 2 along the same path as that during the previous time period.

Thereafter, at the timing t72, the currents ILr and IQclamp may change in polarity from positive to negative, as illustrated in parts (F) and (H) of FIG. 11. Accordingly, during a time period from the timing t72 to the timing t73, current may flow through the primary-side circuitry of the electric power conversion apparatus 2 as illustrated in FIG. 12L. Through the winding 16A of the transformer 16, current may flow in the direction from the node N12 toward the inductor 14. Further, as illustrated in FIG. 12L, current may flow through the secondary-side circuitry of the electric power conversion apparatus 2 along the same path as that during the previous time period.

Thereafter, at the timing t73, the currents ILch and IQfly may change in polarity from positive to negative, as illustrated in parts (I) and (K) of FIG. 11. Accordingly, during a time period from the timing t73 to a timing t74, current may flow through the secondary-side circuitry of the electric power conversion apparatus 2 as illustrated in FIG. 12M. Through the inductor 19, the current ILch may flow in the direction from the voltage line L21B toward the voltage line L21A. Further, as illustrated in FIG. 12M, current may flow through the primary-side circuitry of the electric power conversion apparatus 2 along the same path as that during the previous time period.

Thereafter, at the timing t74, the control circuit 130 may change the control signal Gclamp from the high level to the low level, and change the control signal Gfwd from the low level to the high level, as illustrated in parts (B) and (C) of FIG. 11. This operation is the same as the operation performed at the timing t61.

When the output current Iout is small, the electric power conversion apparatus 2 may repeat the foregoing operations performed from the timing t61 to the timing t74.

Here, the operation from the timing t69 to the timing t70 may correspond to a specific but non-limiting example of the “first operation” in one embodiment of the disclosure. The operation from the timing t70 to the timing t74 may correspond to a specific but non-limiting example of the “second operation” in one embodiment of the disclosure. The operation from the timing t61 to the timing t62 may correspond to a specific but non-limiting example of the “third operation” in one embodiment of the disclosure. The operation from the timing t62 to the timing t64 may correspond to a specific but non-limiting example of the “fourth operation” in one embodiment of the disclosure. The operation from the timing t64 to the timing t67 may correspond to a specific but non-limiting example of the “fifth operation” in one embodiment of the disclosure. The operation from the timing t67 to the timing t69 may correspond to a specific but non-limiting example of the “sixth operation” in one embodiment of the disclosure.

As has been described, the electric power conversion apparatus 2 may be configured to: in the second operation (the operation from the timing t70 to the timing t74), allow current to flow through the smoothing circuit 18, the sixth node (the reference voltage line L22), the fourth switching device (the transistor Qfly), and the fourth node (the voltage line L21A) in this order along a first circulation path including the smoothing circuit 18, the sixth node (the reference voltage line L22), the fourth switching device (the transistor Qfly), and the fourth node (the voltage line L21A), and to thereafter flow in reverse order along the first circulation path; and in the fifth operation (the operation from the timing t64 to the timing t67), allow current to flow through the smoothing circuit 18, the fourth node (the voltage line L21A), the second winding (the winding 16B), the fifth node (the node N13), the third switching device (the transistor Qfwd), and the sixth node (the reference voltage line L22) in this order along a second circulation path including the smoothing circuit 18, the fourth node (the voltage line L21A), the second winding (the winding 16B), the fifth node (the node N13), the third switching device (the transistor Qfwd), and the sixth node (the reference voltage line L22), and to thereafter flow in reverse order along the second circulation path. The electric power conversion apparatus 2 may thus transmit electric power from the primary-side circuitry to the secondary-side circuitry during the time period from the timing t65 to the timing t73 within the time period corresponding to one period, and transmit electric power from the secondary-side circuitry to the primary-side circuitry during the other time periods within the time period corresponding to one period. Accordingly, the current ILch in the electric power conversion apparatus 2 may alternate between positive and negative values, as illustrated in part (I) of FIG. 11. The electric power conversion apparatus 2 may repeatedly alternate the operation to transmit electric power from the primary-side circuitry to the secondary-side circuitry and the operation to transmit electric power from the secondary-side circuitry to the primary-side circuitry. This helps to allow the electric power conversion apparatus 2 to provide stable operations even when the output current Iout is small.

### Third Example Embodiment

Next, a description will be given of an electric power conversion apparatus 3 according to a third example embodiment. Note that components substantially the same as those in the electric power conversion apparatus 1 according to the foregoing first example embodiment are denoted with the same reference signs and descriptions thereof are omitted where appropriate.

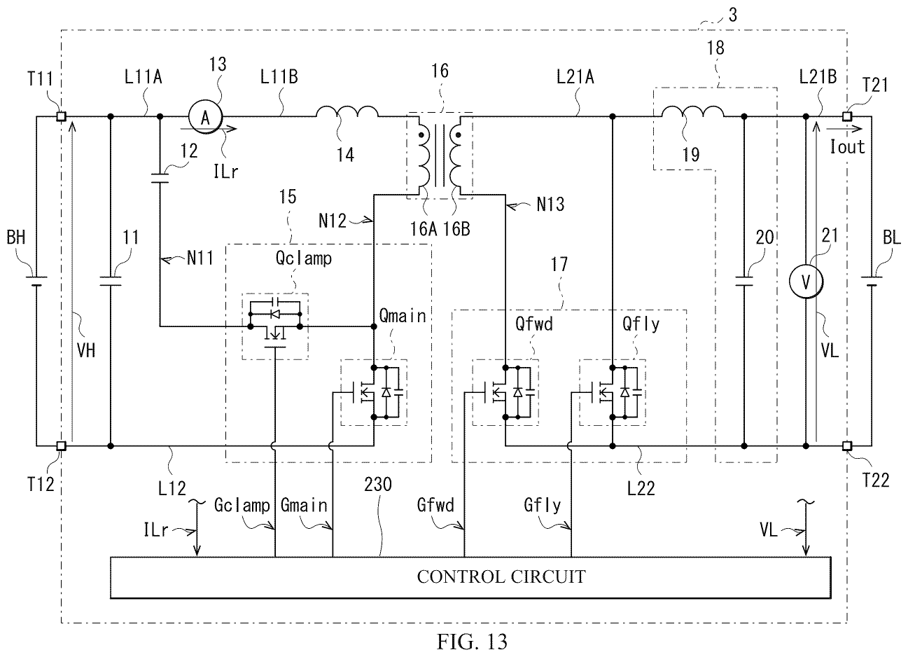

FIG. 13 illustrates a configuration example of the electric power conversion apparatus 3. The electric power conversion apparatus 3 includes a control circuit 230. As with the control circuit 30 according to the foregoing first example embodiment, the control circuit 230 may be configured to control the operation of the electric power conversion apparatus 3, based on the current ILr detected by the current sensor 13 and the voltage VL detected by the voltage sensor 21.

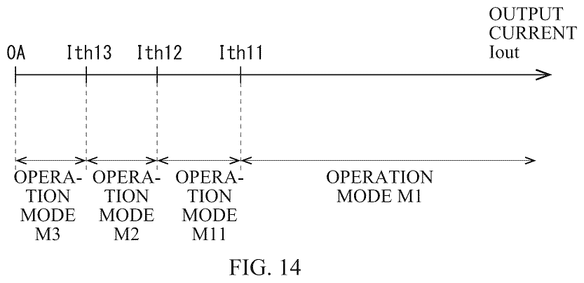

FIG. 14 illustrates an example of operation modes of the electric power conversion apparatus 3. The electric power conversion apparatus 3 may have four operation modes M1 to M3 and M11. The control circuit 230 may set the operation mode of the electric power conversion apparatus 3 to any one of the four operation modes corresponding to the output current Iout, based on the current ILr.

For example, the control circuit 230 may set the operation mode of the electric power conversion apparatus 3 to the operation mode M1 when the output current Iout is greater than a threshold Ith11. The control circuit 230 may set the operation mode of the electric power conversion apparatus 3 to the operation mode M11 when the output current Iout is less than or equal to the threshold Ith11 and greater than a threshold Ith12. The control circuit 230 may set the operation mode of the electric power conversion apparatus 3 to the operation mode M2 when the output current Iout is less than or equal to the threshold Ith12 and greater than a threshold Ith13. The control circuit 230 may set the operation mode of the electric power conversion apparatus 3 to the operation mode M3 when the output current Iout is less than or equal to the threshold Ith13. The operation modes M1 to M3 may be similar to those in the foregoing first example embodiment. The operation mode M11 will be described in detail below.

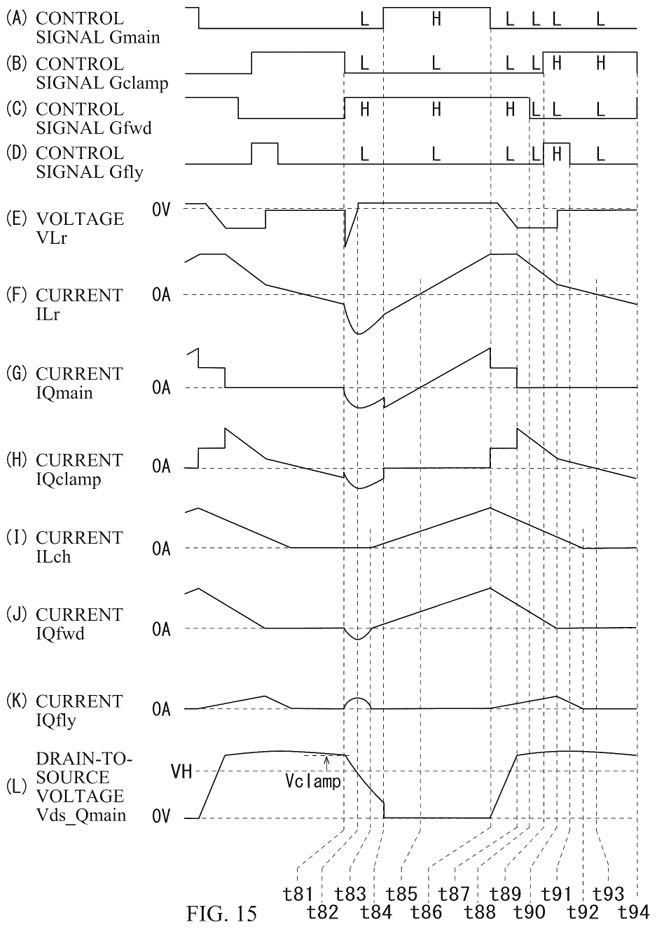

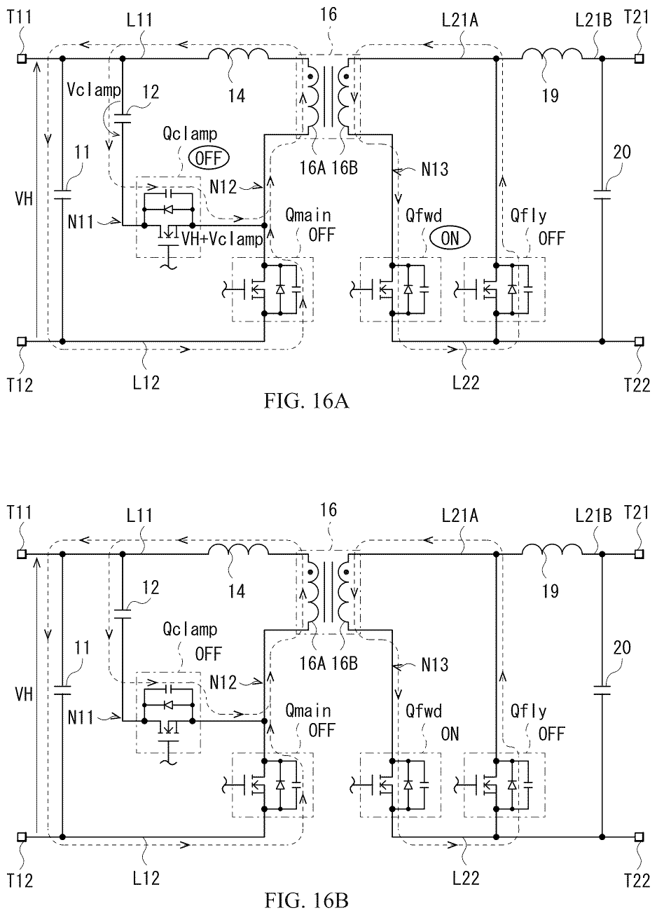

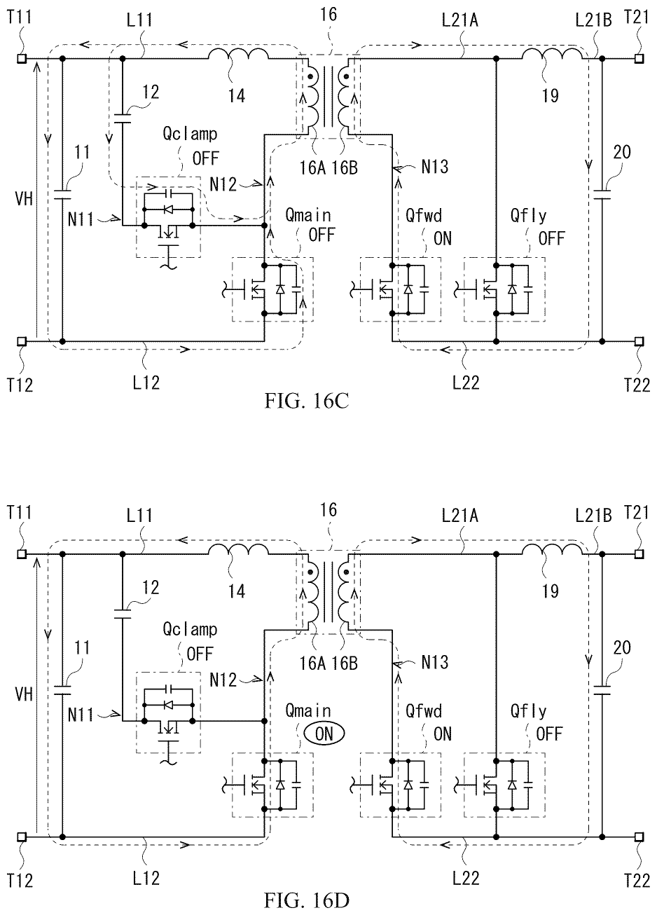

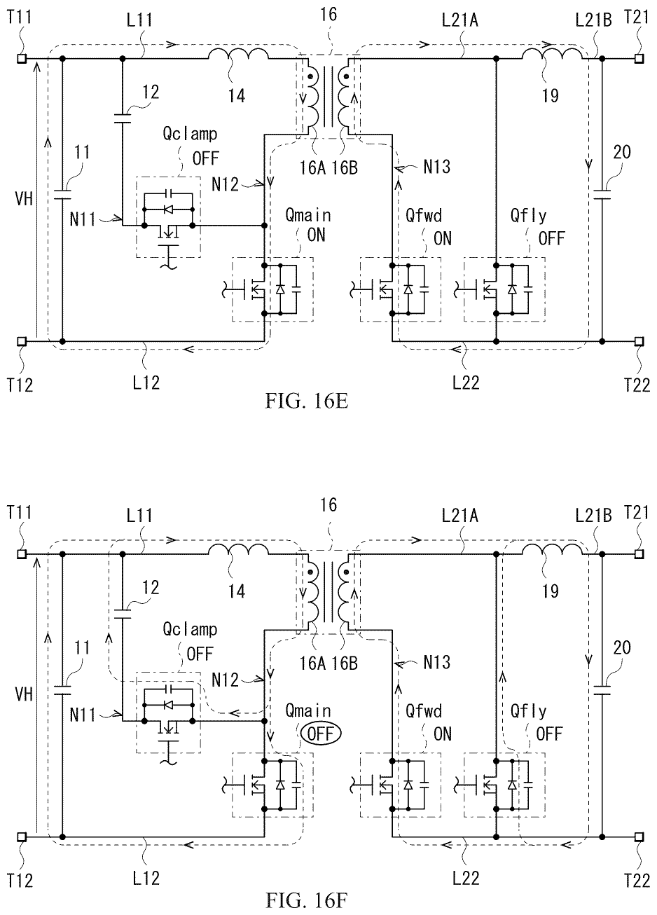

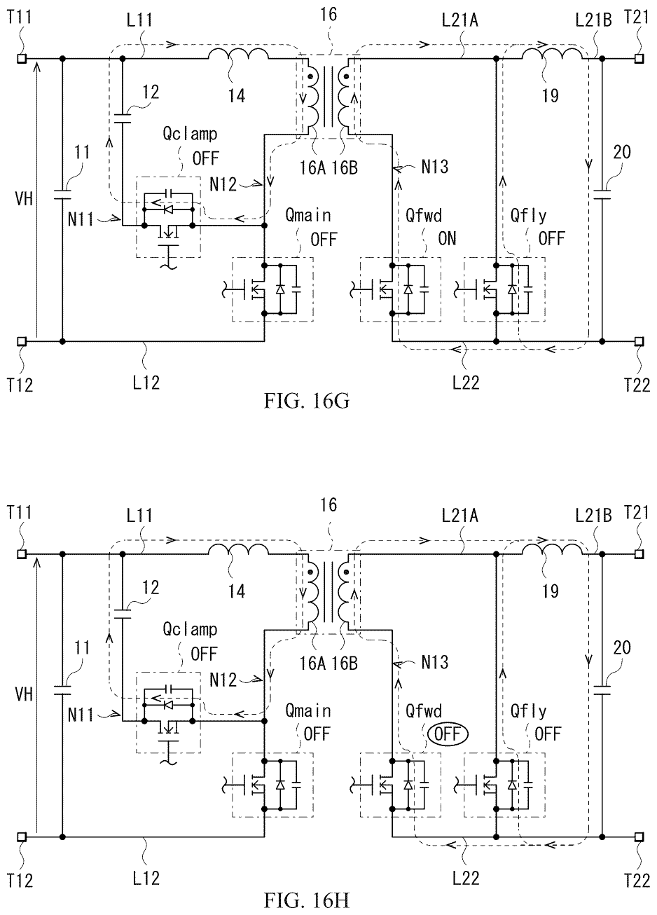

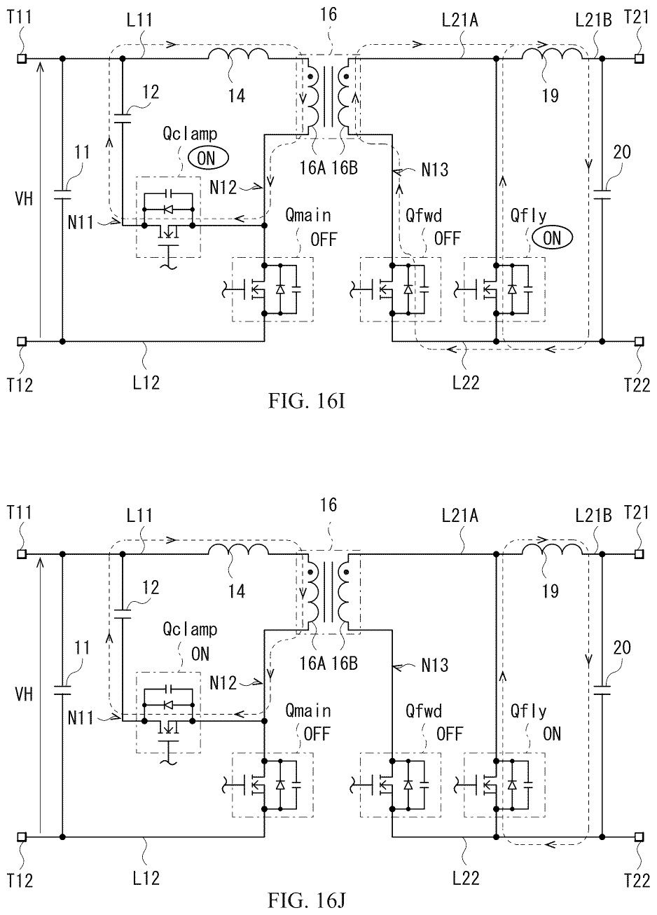

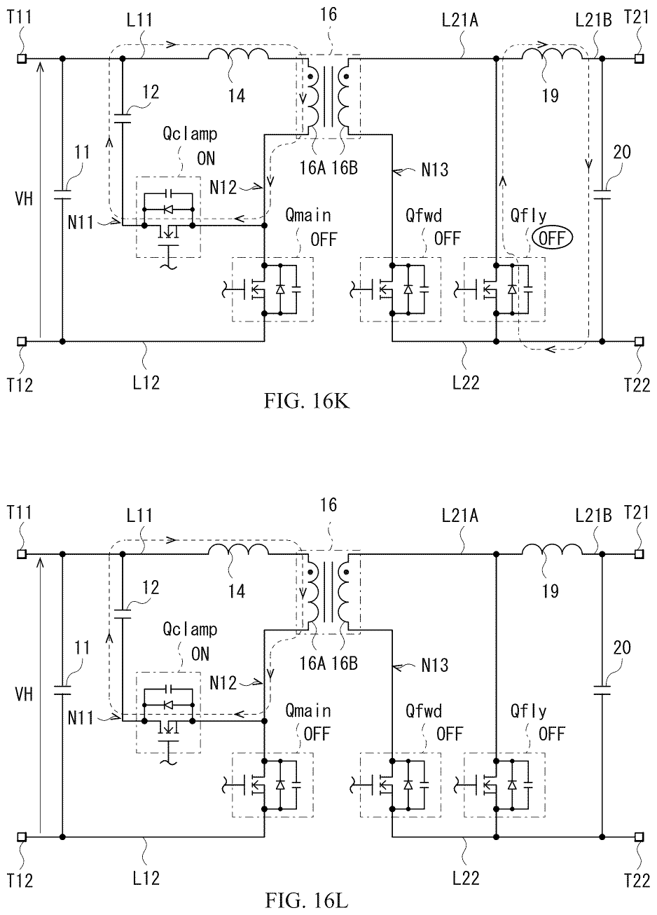

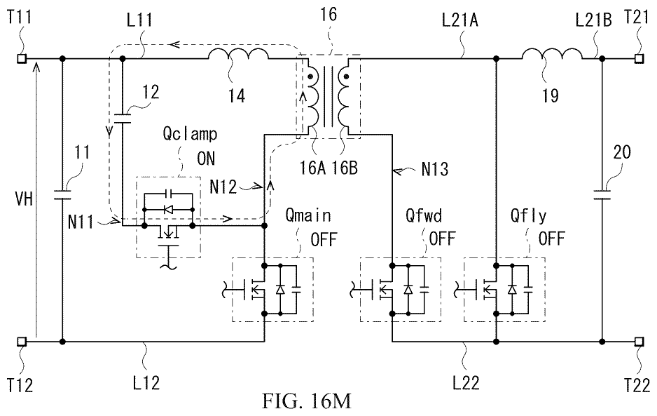

FIG. 15 illustrates an operation example of the electric power conversion apparatus 3 in the operation mode M11. FIGS. 16A to 16M illustrate operation states of the electric power conversion apparatus 3 during various time periods in FIG. 15.

At a timing t81, the control circuit 230 may change the control signal Gclamp from the high level to the low level, and change the control signal Gfwd from the low level to the high level, as illustrated in parts (B) and (C) of FIG. 15. This may cause the transistor Qclamp to change from on to off, and cause the transistor Qfwd to change from off to on, as illustrated in FIG. 16A. The transistors Qmain and Qfly may both be off. At the timing t81, the drain-to-source voltage Vds_Qmain of the transistor Qmain may be a voltage (VH+Vclamp) corresponding to the sum of the voltage VH at the terminals T11 and T12 and the voltage Vclamp of the capacitor 12, as illustrated in part (L) of FIG. 15 and FIG. 16A. Accordingly, at the timing t81, the voltage at the node N12 may be higher than the voltage at the voltage line L11. During a time period from the timing t81 to a timing t82, current may flow through the primary-side circuitry of the electric power conversion apparatus 3 as illustrated in FIG. 16A. Through the winding 16A of the transformer 16, current may flow in the direction from the node N12 toward the inductor 14. The absolute value of this current (the current ILr) may increase, as illustrated in part (F) of FIG. 15. Through the transistor Qmain, current may flow from the source toward the drain via the parasitic capacitor. As a result, the parasitic capacitor of the transistor Qmain may be gradually discharged, which may cause the drain-to-source voltage Vds_Qmain to drop, as illustrated in part (L) of FIG. 15. Further, current may flow through the secondary-side circuity of the electric power conversion apparatus 3 as illustrated in FIG. 16A. No current ILch may flow through the inductor 19, as illustrated in part (I) of FIG. 15.

Thereafter, at the timing t82, the voltage VL may change in polarity from negative to positive, as illustrated in part (E) of FIG. 15. This may cause the voltage at the first end of the winding 16A of the transformer 16 to become lower than the voltage at the voltage line L11B. During a time period from the timing t82 to a timing t83, as illustrated in FIG. 16B, current may flow through each of the primary-side circuity and the secondary-side circuitry of the electric power conversion apparatus 3 along the same path as that during the previous time period. The respective absolute values of the currents ILr, IQmain, and IQclamp in the primary-side circuitry may start to decrease, as illustrated in parts (F), (G), and (H) of FIG. 15, and the respective absolute values of the currents IQfwd and IQfly in the secondary-side circuitry may start to decrease, as illustrated in parts (J) and (K) of FIG. 15. The drain-to-source voltage Vds_Qmain may continue to drop, and may fall below the voltage VH at a certain timing in a time period from the timing t81 to the timing t83, as illustrated in part (L) of FIG. 15.

Thereafter, at the timing t83, the currents IQfwd and IQfly may become 0 A, as illustrated in parts (J) and (K) of FIG. 15. During a time period from the timing t83 to a timing t84, current may flow through the secondary-side circuitry of the electric power conversion apparatus 3 as illustrated in FIG. 16C. In the secondary-side circuitry, as illustrated in part (I) of FIG. 15, the current ILch may start to flow through the inductor 19 in the direction from the voltage line L21A toward the voltage line L21B. Further, the absolute value of the current IQfwd may start to increase, as illustrated in part (J) of FIG. 15. Further, as illustrated in FIG. 16C, current may flow through the primary-side circuitry of the electric power conversion apparatus 3 along the same path as that during the previous time period.

Thereafter, at the timing t84, the control circuit 230 may change the control signal Gmain from the low level to the high level, as illustrated in part (A) of FIG. 15. This may cause the transistor Qmain to change from off to on, as illustrated in FIG. 16D. Due to the transistor Qmain turning on, the drain-to-source voltage Vds_Qmain may become 0 V, as illustrated in part (L) of FIG. 15. During a time period from the timing t84 to a timing t85, current may flow through the primary-side circuitry of the electric power conversion apparatus 3 as illustrated in FIG. 16D. Further, as illustrated in FIG. 16D, current may flow through the secondary-side circuitry of the electric power conversion apparatus 3 along the same path as that during the previous time period.

Thereafter, at the timing t85, the currents ILr and IQmain may change in polarity from negative to positive, as illustrated in parts (F) and (G) of FIG. 15. Accordingly, during a time period from the timing t85 to a timing t86, current may flow through the primary-side circuitry of the electric power conversion apparatus 3 as illustrated in FIG. 16E. Through the winding 16A of the transformer 16, current may flow in the direction from the inductor 14 toward the node N12. Further, as illustrated in FIG. 16E, current may flow through the secondary-side circuitry of the electric power conversion apparatus 3 along the same path as that during the previous time period.

Thereafter, at the timing t86, the control circuit 230 may change the control signal Gmain from the high level to the low level, as illustrated in part (A) of FIG. 15. This may cause the transistor Qmain to change from on to off, as illustrated in FIG. 16F. Accordingly, during a time period from the timing t86 to a timing t87, current may flow through the primary-side circuitry of the electric power conversion apparatus 3 as illustrated in FIG. 16F. Through the transistor Qmain, current may flow from the drain toward the source via the parasitic capacitor. As a result, the parasitic capacitor of the transistor Qmain may be gradually charged, which may cause the drain-to-source voltage Vds_Qmain to rise, as illustrated in part (L) of FIG. 15. Further, current may flow through the secondary-side circuity of the electric power conversion apparatus 3 as illustrated in FIG. 16F. In the secondary-side circuitry, the absolute value of the current IQfwd may start to decrease, and the absolute value of the current IQfly may start to increase from 0 A, as illustrated in parts (J) and (K) of FIG. 15. At the timing t86, the absolute value of the current ILch may change from increasing to decreasing, as illustrated in part (I) of FIG. 15.

Thereafter, at the timing t87, the charging of the parasitic capacitor of the transistor Qmain may end, and accordingly, the voltage at the node N12 may become higher than the voltage at the voltage line L11. During a time period from the timing t87 to a timing t88, current may flow through the primary-side circuitry of the electric power conversion apparatus 3 as illustrated in FIG. 16G. Due to the charging of the parasitic capacitor of the transistor Qmain having ended, no current may flow through the transistor Qmain, as illustrated in part (G) of FIG. 15. The absolute value of the current ILr in the primary-side circuitry may start to decrease, as illustrated in part (F) of FIG. 15. Further, as illustrated in FIG. 16G, current may flow through the secondary-side circuitry of the electric power conversion apparatus 3 along the same path as that during the previous time period.

Thereafter, at the timing t88, the control circuit 230 may change the control signal Gfwd from the high level to the low level, as illustrated in part (C) of FIG. 15. This may cause the transistor Qfwd to change from on to off, as illustrated in FIG. 16H. During a time period from the timing t88 to a timing t89, current may flow through the secondary-side circuitry of the electric power conversion apparatus 3 as illustrated in FIG. 16H. Further, as illustrated in FIG. 16H, current may flow through the primary-side circuity of the electric power conversion apparatus 3 along the same path as that during the previous time period.

Thereafter, at the timing t89, the control circuit 230 may change the control signals Gclamp and Gfly from the low level to the high level, as illustrated in parts (B) and (D) of FIG. 15. This may cause the transistors Qclamp and Qfly to change from off to on, as illustrated in FIG. 16I. Accordingly, during a time period from the timing t89 to a timing t90, current may flow through each of the primary-side circuity and the secondary-side circuitry of the electric power conversion apparatus 3 as illustrated in FIG. 16I.

Thereafter, at the timing t90, the current IQfwd in the secondary-side circuitry may become 0 A, as illustrated in part (J) of FIG. 15. During a time period from the timing t90 to a timing t91, current may flow through the secondary-side circuitry of the electric power conversion apparatus 3 as illustrated in FIG. 16J. In the secondary-side circuitry, the absolute value of the current IQfly may start to decrease, as illustrated in part (K) of FIG. 15. Further, as illustrated in FIG. 16J, current may flow through the primary-side circuity of the electric power conversion apparatus 3 along the same path as that during the previous time period.

Thereafter, at the timing t91, the control circuit 230 may change the control signal Gfly from the high level to the low level, as illustrated in part (D) of FIG. 15. This may cause the transistor Qfly to change from on to off, as illustrated in FIG. 16K. During a time period from the timing t91 to a timing t92, current may flow through the secondary-side circuitry of the electric power conversion apparatus 3 as illustrated in FIG. 16K. Further, as illustrated in FIG. 16K, current may flow through the primary-side circuitry of the electric power conversion apparatus 3 along the same path as that during the previous time period.

Thereafter, at the timing t92, the respective absolute values of the currents ILch and IQfly may both become 0 A, as illustrated in parts (I) and (K) of FIG. 15. Accordingly, during a time period from the timing t92 to a timing t93, no current may flow through the secondary-side circuitry of the electric power conversion apparatus 3, as illustrated in FIG. 16L. Further, as illustrated in FIG. 16L, current may flow through the primary-side circuitry of the electric power conversion apparatus 3 along the same path as that during the previous time period.

Thereafter, at the timing t93, the currents ILr and IQclamp in the primary-side circuitry may change in polarity from positive to negative, as illustrated in parts (F) and (H) of FIG. 15. Accordingly, during a time period from the timing t93 to a timing t94, current may flow through the primary-side circuitry of the electric power conversion apparatus 3 as illustrated in FIG. 16M. Through the winding 16A of the transformer 16, current may flow in the direction from the node N12 toward the inductor 14. Further, as illustrated in FIG. 16M, no current may flow through the secondary-side circuitry of the electric power conversion apparatus 3, as with the previous time period.

Thereafter, at the timing t94, the control circuit 230 may change the control signal Gclamp from the high level to the low level, and change the control signal Gfwd from the low level to the high level, as illustrated in parts (B) and (C) of FIG. 15. This operation is the same as the operation performed at the timing t81.

In the operation mode M11, the electric power conversion apparatus 3 may repeat the foregoing operations performed from the timing t81 to the timing t94.

In such a manner, the control circuit 230 may set the operation mode of the electric power conversion apparatus 3 to any one of the operation modes M1, M11, M2, and M3 described above. For example, as illustrated in FIG. 14, the control circuit 230 may set the operation mode of the electric power conversion apparatus 3 to the operation mode M1 when the output current Iout is greater than the threshold Ith11. The control circuit 230 may set the operation mode of the electric power conversion apparatus 3 to the operation mode M11 when the output current Iout is less than or equal to the threshold Ith11 and greater than the threshold Ith12. The control circuit 230 may set the operation mode of the electric power conversion apparatus 3 to the operation mode M2 when the output current Iout is less than or equal to the threshold Ith12 and greater than the threshold Ith13. The control circuit 230 may set the operation mode of the electric power conversion apparatus 3 to the operation mode M3 when the output current Iout is less than or equal to the threshold Ith13.

The threshold Ith11 may be similar to the threshold Ith1 according to the first example embodiment, and may be, for example, set for the output current Iout that allows, in the operation mode M1, the lowest current value Imin of the current ILch illustrated in part (I) of FIG. 3 to be 0 A.

The threshold Ith12 may be set by, for example, making a comparison between efficiency in the operation mode M11 and efficiency in the operation mode M2. For example, the threshold Ith12 may be set to allow the efficiency in the operation mode M11 to be higher than the efficiency in the operation mode M2 when the output current Iout is greater than the threshold Ith12, and to allow the efficiency in the operation mode M2 to be higher than the efficiency in the operation mode M11 when the output current Iout is less than or equal to the threshold Ith12.

The threshold Ith13 may be similar to the threshold Ith2 according to the first example embodiment, and may be set for the output current Iout that allows, in the operation mode M2, the duty ratio of the control signal Gmain to be equal to the lower limit of the duty ratio of the control signal Gmain that the control circuit 230 can generate.

Here, the control according to the operation mode M11 may correspond to a specific but non-limiting example of “second control” in one embodiment of the disclosure. The control according to the operation mode M2 may correspond to a specific but non-limiting example of “third control” in one embodiment of the disclosure. The control according to the operation mode M3 may correspond to a specific but non-limiting example of “fourth control” in one embodiment of the disclosure. The threshold Ith11 may correspond to a specific but non-limiting example of a “first threshold” in one embodiment of the disclosure. The threshold Ith12 may correspond to a specific but non-limiting example of a “second threshold” in one embodiment of the disclosure. The threshold Ith13 may correspond to a specific but non-limiting example of a “third threshold” in one embodiment of the disclosure. The operation from the timing t88 to the timing t89 may correspond to a specific but non-limiting example of a “seventh operation” in one embodiment of the disclosure. The operation from the timing t89 to the timing t91 may correspond to a specific but non-limiting example of an “eighth operation” in one embodiment of the disclosure. The operation from the timing t91 to the timing t94 may correspond to a specific but non-limiting example of a “ninth operation” in one embodiment of the disclosure. The operation from the timing t81 to the timing t84 may correspond to a specific but non-limiting example of a “tenth operation” in one embodiment of the disclosure. The operation from the timing t84 to the timing t86 may correspond to a specific but non-limiting example of an “eleventh operation” in one embodiment of the disclosure. The operation from the timing t86 to the timing t88 may correspond to a specific but non-limiting example of a “twelfth operation” in one embodiment of the disclosure.

The control circuit 230 may be configured to perform the first control (the control in the operation mode M1) when a current value of the current flowing through the second electric power terminal (T21 and T22) is greater than the first threshold (the threshold Ith11), and configured to, when the current value of the current flowing through the second electric power terminal (T21 and T22) is less than or equal to the first threshold (the threshold Ith11), control the operations of the switching circuit 15 and the rectifying circuit 17 by performing the second control (the control in the operation mode M11) in which the seventh operation (the operation from the timing t88 to the timing t89), the eighth operation (the operation from the timing t89 to the timing t91), the ninth operation (the operation from the timing t91 to the timing t94), the tenth operation (the operation from the timing t81 to the timing t84), the eleventh operation (the operation from the timing t84 to the timing t86), and the twelfth operation (the operation from the timing t86 to the timing t88) are performed in this order repeatedly. The seventh operation (the operation from the timing t88 to the timing t89) includes causing the first switching device (the transistor Qmain), the second switching device (the transistor Qclamp), the third switching device (the transistor Qfwd), and the fourth switching device (the transistor Qfly) to be off. The eighth operation (the operation from the timing t89 to the timing t91) includes causing the second switching device (the transistor Qclamp) and the fourth switching device (the transistor Qfly) to be on and causing the first switching device (the transistor Qmain) and the third switching device (the transistor Qfwd) to be off. The ninth operation (the operation from the timing t91 to the timing t94) includes causing the second switching device (the transistor Qclamp) to be on and causing the first switching device (the transistor Qmain), the third switching device (the transistor Qfwd), and the fourth switching device (the transistor Qfly) to be off. The tenth operation (the operation from the timing t81 to the timing t84) includes causing the third switching device (the transistor Qfwd) to be on and causing the first switching device (the transistor Qmain), the second switching device (the transistor Qclamp), and the fourth switching device (the transistor Qfly) to be off. The eleventh operation (the operation from the timing t84 to the timing t86) includes causing the first switching device (the transistor Qmain) and the third switching device (the transistor Qfwd) to be on and causing the second switching device (the transistor Qclamp) and the fourth switching device (the transistor Qfly) to be off. The twelfth operation (the operation from the timing t86 to the timing t88) includes causing the third switching device (the transistor Qfwd) to be on and causing the first switching device (the transistor Qmain), the second switching device (the transistor Qclamp), and the fourth switching device (the transistor Qfly) to be off. With such a configuration, as compared with the electric power conversion apparatus 1 according to the first example embodiment, the electric power conversion apparatus 3 helps to achieve increased efficiency when the output current Iout is less than the threshold Ith1.

The disclosure has been described hereinabove with reference to the example embodiments. However, the disclosure is not limited thereto, and various modifications may be made.

For example, in the foregoing example embodiments, the electric power conversion apparatuses 1 to 3 may each perform a step-down operation in converting electric power; however, this is non-limiting. In some embodiments, the electric power conversion apparatuses 1 to 3 may each perform a step-up operation.

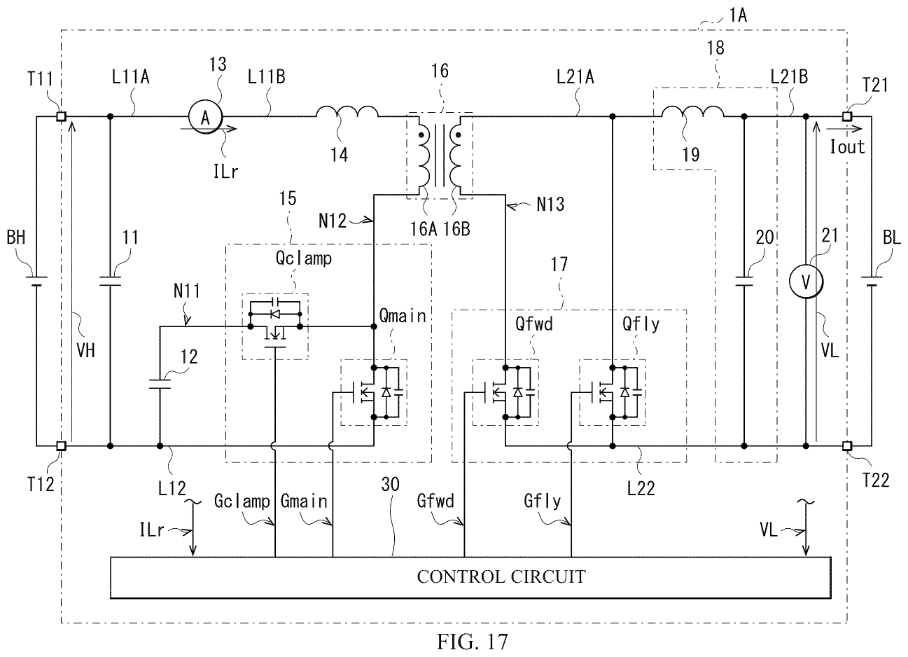

For example, in the first example embodiment, the electric power conversion apparatus 1 may have the circuit configuration illustrated in FIG. 1; however, this is non-limiting. In some embodiments, the capacitor 12 may be coupled in a different manner, as in an electric power conversion apparatus 1A illustrated in FIG. 17, for example. In the electric power conversion apparatus 1A, the first end of the capacitor 12 may be coupled to the reference voltage line L12, and the second end of the capacitor 12 may be coupled to the node N11. Although reference has been made to the electric power conversion apparatus 1 according to the first example embodiment in describing the present modification example, the present modification example may be applied to the electric power conversion apparatus 2 according to the second example embodiment illustrated in FIG. 10, or to the electric power conversion apparatus 3 according to the third example embodiment illustrated in FIG. 13.

The effects described herein are mere examples, and effects of an embodiment of the disclosure are not limited thereto. Accordingly, any other effect may be obtained in relation to the embodiment of the disclosure.

The disclosure encompasses any possible combination of some or all of the various embodiments and the modification examples described herein and incorporated herein. An embodiment of the disclosure may have any of the following configurations.

(1)
An electric power conversion apparatus including:
   a first electric power terminal including a first coupling terminal and a second coupling terminal;
   an inductor having a first end coupled to the first coupling terminal and a second end coupled to a first node;
   a capacitor having a first end coupled to the first coupling terminal or the second coupling terminal and a second end coupled to a second node;
   a switching circuit including a first switching device and a second switching device, the first switching device having a first end coupled to a third node and a second end coupled to the second coupling terminal, the second switching device having a first end coupled to the second node and a second end coupled to the third node;
   a transformer including a first winding and a second winding, the first winding having a first end coupled to the first node and a second end coupled to the third node, the second winding having a first end coupled to a fourth node and a second end coupled to a fifth node;
   a rectifying circuit including a third switching device and a fourth switching device, the third switching device having a first end coupled to the fifth node and a second end coupled to a sixth node, the fourth switching device having a first end coupled to the fourth node and a second end coupled to the sixth node;
   a smoothing circuit coupled to the fourth node and the sixth node;
   a second electric power terminal coupled to the smoothing circuit; and
   a control circuit configured to control operations of the switching circuit and the rectifying circuit by performing first control in which a first operation, a second operation, a third operation, a fourth operation, a fifth operation, and a sixth operation are performed in this order repeatedly, in which
   the first operation includes causing the first switching device, the second switching device, the third switching device, and the fourth switching device to be off,
   the second operation includes causing the second switching device and the fourth switching device to be on and causing the first switching device and the third switching device to be off,
   the third operation includes causing the third switching device and the fourth switching device to be on and causing the first switching device and the second switching device to be off,
   the fourth operation includes causing the third switching device to be on and causing the first switching device, the second switching device, and the fourth switching device to be off,
   the fifth operation includes causing the first switching device and the third switching device to be on and causing the second switching device and the fourth switching device to be off, and
   the sixth operation includes causing the third switching device to be on and causing the first switching device, the second switching device, and the fourth switching device to be off.

(2)
The electric power conversion apparatus according to (1), in which the electric power conversion apparatus is configured to, in a time period during which the control circuit is performing the third operation, allow a first voltage across the first switching device to change from a voltage higher than a second voltage between the first coupling terminal and the second coupling terminal to a voltage lower than the second voltage.

(3)
The electric power conversion apparatus according to (1) or (2), in which the electric power conversion apparatus is configured to:
   in the second operation, allow current to flow through the smoothing circuit, the sixth node, the fourth switching device, and the fourth node in this order along a first circulation path including the smoothing circuit, the sixth node, the fourth switching device, and the fourth node, and to thereafter flow in reverse order along the first circulation path; and
   in the fifth operation, allow current to flow through the smoothing circuit, the fourth node, the second winding, the fifth node, the third switching device, and the sixth node in this order along a second circulation path including the smoothing circuit, the fourth node, the second winding, the fifth node, the third switching device, and the sixth node, and to thereafter flow in reverse order along the second circulation path.

(4)
The electric power conversion apparatus according to (1) or (2), in which the control circuit is configured to:
   perform the first control when a current value of a current flowing through the second electric power terminal is greater than a first threshold; and
   when the current value of the current flowing through the second electric power terminal is less than or equal to the first threshold, control the operations of the switching circuit and the rectifying circuit by performing second control in which a seventh operation, an eighth operation, a ninth operation, a tenth operation, an eleventh operation, and a twelfth operation are performed in this order repeatedly,
   the seventh operation includes causing the first switching device, the second switching device, the third switching device, and the fourth switching device to be off,
   the eighth operation includes causing the second switching device and the fourth switching device to be on and causing the first switching device and the third switching device to be off,
   the ninth operation includes causing the second switching device to be on and causing the first switching device, the third switching device, and the fourth switching device to be off,
   the tenth operation includes causing the third switching device to be on and causing the first switching device, the second switching device, and the fourth switching device to be off,
   the eleventh operation includes causing the first switching device and the third switching device to be on and causing the second switching device and the fourth switching device to be off, and
   the twelfth operation includes causing the third switching device to be on and causing the first switching device, the second switching device, and the fourth switching device to be off.

(5)
The electric power conversion apparatus according to (4), in which the control circuit is configured to, when the current value of the current flowing through the second electric power terminal falls below a second threshold less than the first threshold, control the operations of the switching circuit and the rectifying circuit by performing third control that causes the first switching device and the second switching device to alternately turn on and causes the third switching device and the fourth switching device to remain off.

(6)
The electric power conversion apparatus according to (5), in which the control circuit is configured to, when the current value of the current flowing through the second electric power terminal falls below a third threshold less than the second threshold, control the operations of the switching circuit and the rectifying circuit by performing fourth control in which the third control is performed intermittently.

An electric power conversion apparatus according to at least one embodiment of the disclosure makes it possible to reduce energy loss.

Although the disclosure has been described hereinabove in terms of the example embodiment and modification examples, the disclosure is not limited thereto. It should be appreciated that variations may be made in the described example embodiment and modification examples by those skilled in the art without departing from the scope of the disclosure as defined by the following claims.

The limitations in the claims are to be interpreted broadly based on the language employed in the claims and not limited to examples described in this specification or during the prosecution of the application, and the examples are to be construed as non-exclusive.

As used in this specification and the appended claims, the singular forms “a,” “an,” and “the” include, especially in the context of the claims, are to be construed to cover both the singular and the plural, unless otherwise indicated herein or clearly contradicted by context.

Throughout this specification and the appended claims, unless the context requires otherwise, the terms “comprise”, “include”, “have”, and their variations are to be construed to cover the inclusion of a stated element, integer or step but not the exclusion of any other non-stated element, integer or step.

The use of the terms first, second, etc. do not denote any order or importance, but rather the terms first, second, etc. are used to distinguish one element from another.

The term “substantially”, “approximately”, “about”, and its variants having the similar meaning thereto are defined as being largely but not necessarily wholly what is specified as understood by one of ordinary skill in the art.

The term “disposed on/provided on/formed on” and its variants having the similar meaning thereto as used herein refer to elements disposed directly in contact with each other or indirectly by having intervening structures therebetween.

What is claimed is

1. An electric power conversion apparatus comprising:
a first electric power terminal including a first coupling terminal and a second coupling terminal;
an inductor having a first end coupled to the first coupling terminal and a second end coupled to a first node;
a capacitor having a first end coupled to the first coupling terminal or the second coupling terminal and a second end coupled to a second node;
a switching circuit including a first switching device and a second switching device, the first switching device having a first end coupled to a third node and a second end coupled to the second coupling terminal, the second switching device having a first end coupled to the second node and a second end coupled to the third node;
a transformer including a first winding and a second winding, the first winding having a first end coupled to the first node and a second end coupled to the third node, the second winding having a first end coupled to a fourth node and a second end coupled to a fifth node;
a rectifying circuit including a third switching device and a fourth switching device, the third switching device having a first end coupled to the fifth node and a second end coupled to a sixth node, the fourth switching device having a first end coupled to the fourth node and a second end coupled to the sixth node;
a smoothing circuit coupled to the fourth node and the sixth node;
a second electric power terminal coupled to the smoothing circuit; and
a control circuit configured to control operations of the switching circuit and the rectifying circuit by performing first control in which a first operation, a second operation, a third operation, a fourth operation, a fifth operation, and a sixth operation are performed in this order repeatedly, wherein
the first operation includes causing the first switching device, the second switching device, the third switching device, and the fourth switching device to be off,
the second operation includes causing the second switching device and the fourth switching device to be on and causing the first switching device and the third switching device to be off,
the third operation includes causing the third switching device and the fourth switching device to be on and causing the first switching device and the second switching device to be off,
the fourth operation includes causing the third switching device to be on and causing the first switching device, the second switching device, and the fourth switching device to be off,
the fifth operation includes causing the first switching device and the third switching device to be on and causing the second switching device and the fourth switching device to be off, and
the sixth operation includes causing the third switching device to be on and causing the first switching device, the second switching device, and the fourth switching device to be off.

2. The electric power conversion apparatus according to claim 1, wherein the electric power conversion apparatus is configured to, in a time period during which the control circuit is performing the third operation, allow a first voltage across the first switching device to change from a voltage higher than a second voltage between the first coupling terminal and the second coupling terminal to a voltage lower than the second voltage.

3. The electric power conversion apparatus according to claim 1, wherein the electric power conversion apparatus is configured to:
in the second operation, allow current to flow through the smoothing circuit, the sixth node, the fourth switching device, and the fourth node in this order along a first circulation path including the smoothing circuit, the sixth node, the fourth switching device, and the fourth node, and to thereafter flow in reverse order along the first circulation path; and
in the fifth operation, allow current to flow through the smoothing circuit, the fourth node, the second winding, the fifth node, the third switching device, and the sixth node in this order along a second circulation path including the smoothing circuit, the fourth node, the second winding, the fifth node, the third switching device, and the sixth node, and to thereafter flow in reverse order along the second circulation path.

4. The electric power conversion apparatus according to claim 1, wherein
the control circuit is configured to:
perform the first control when a current value of a current flowing through the second electric power terminal is greater than a first threshold; and
when the current value of the current flowing through the second electric power terminal is less than or equal to the first threshold, control the operations of the switching circuit and the rectifying circuit by performing second control in which a seventh operation, an eighth operation, a ninth operation, a tenth operation, an eleventh operation, and a twelfth operation are performed in this order repeatedly,
the seventh operation includes causing the first switching device, the second switching device, the third switching device, and the fourth switching device to be off,
the eighth operation includes causing the second switching device and the fourth switching device to be on and causing the first switching device and the third switching device to be off,
the ninth operation includes causing the second switching device to be on and causing the first switching device, the third switching device, and the fourth switching device to be off,
the tenth operation includes causing the third switching device to be on and causing the first switching device, the second switching device, and the fourth switching device to be off,
the eleventh operation includes causing the first switching device and the third switching device to be on and causing the second switching device and the fourth switching device to be off, and
the twelfth operation includes causing the third switching device to be on and causing the first switching device, the second switching device, and the fourth switching device to be off.

5. The electric power conversion apparatus according to claim 4, wherein the control circuit is configured to, when the current value of the current flowing through the second electric power terminal falls below a second threshold less than the first threshold, control the operations of the switching circuit and the rectifying circuit by performing third control that causes the first switching device and the second switching device to alternately turn on and causes the third switching device and the fourth switching device to remain off.

6. The electric power conversion apparatus according to claim 5, wherein the control circuit is configured to, when the current value of the current flowing through the second electric power terminal falls below a third threshold less than the second threshold, control the operations of the switching circuit and the rectifying circuit by performing fourth control in which the third control is performed intermittently.
